(19) United States
(12) Patent Application Publication
(10) Pub. No.: US 2021/0234601 A1
(43) Pub. Date: Jul. 29, 2021

(54) BEAM FAILURE RECOVERY IN NEW RADIO UNLICENSED SPECTRUM

(71) Applicant: CONVIDA WIRELESS, LLC, Wilmington, DE (US)

(72) Inventors: Mohamed AWADIN, Plymouth Meeting, PA (US); Qing LI, Princeton Junction, NJ (US); Lakshmi R. IYER, King of Prussia, PA (US); Joseph M. MURRAY, Schwenksville, PA (US); Yifan LI, Conshohocken, PA (US); Pascal M. ADJAKPLE, Great Neck, NY (US); Guodong ZHANG, Woodbury, NY (US); Allan Y. TSAI, Boonton, NJ (US)

(21) Appl. No.: 17/050,886

(22) PCT Filed: May 10, 2019
(86) PCT No.: PCT/US2019/031811

§ 371 Date: Oct. 27, 2020

Related U.S. Application Data
(60) Provisional application No. 62/669,708, filed on May 10, 2018.

(51) Int. Cl. H04B 7/06; H04W 76/19; H04B 7/08; H04W 24/08; H04W 74/08

(52) U.S. Cl. CPC H04B 7/0695; H04W 76/19; H04W 74/0808; H04W 24/08; H04B 7/088

(57) ABSTRACT

Beam failure recovery may be improved via the use enhanced signaling, counters, and windowing. Signaling may include a beam failure reference signal (BFRS) detection signal, which indicates that an access point (e.g., gNB) has acquired a channel for downlink transmission. Based on the BFRS detection signal, a wireless terminal (e.g., UE) may then monitor a gNB downlink transmission during a maximum channel occupancy time (MCOT). The UE may count missed beam failure reference signal instances and report the count, e.g., via higher layer signaling. Signaling may include a BFRS absence indication reflecting an instance of a BFRS that is not transmitted due to channel unavailability. The UE may then exclude the instance of the BFRS from the count. Signaling may include a gNB response detection signal, which may inform the UE to monitor a gNB downlink transmission. The UE may trigger timer after receiving an access gNB response detection signal.

### CROSS-REFERENCE TO RELATED APPLICATIONS

This application claims the benefit of U.S. Provisional Application No. 62/669,708, filed on May 10, 2018, entitled “Beam failure recovery in new radio unlicensed spectrum”, the content of which is hereby incorporated by reference in its entirety.

### BACKGROUND

Machine-To-Machine (M2M), Internet-of-Things (IoT), and Web-of-Things (WoT) network deployments may include nodes such as M2M/IoT/WoT servers, gateways, and devices which host M2M/IoT/WoT applications and services. Such network deployments may include, for example, constrained networks, wireless sensor networks, wireless mesh networks, mobile ad-hoc networks, and wireless sensor and actuator networks. Operations of devices in such networks may accord with such standards and proposals as: 3GPP TS 36.213, Physical layer procedures for control—Release 13 V13.9, Release 14 V14.6, and Release 15 V15.1.0; and RP-172021, “New SID on NR-based Access to Unlicensed Spectrum,” by Qualcomm.

### SUMMARY

Beam failure recovery may be improved via the use enhanced signaling, counters, and window procedures. For example, a wireless terminal apparatus such as a User Equipment (UE), may receive a beam failure reference signal (BFRS) detection signal from a radio network access point such as a gNB, where the BFRS detection signal indicates the access point has acquired a channel for downlink transmission. The apparatus may then monitor a gNB downlink transmission during a gNB maximum channel occupancy time (MCOT) of the access point, e.g., based on the BFRS detection signal. Similarly, the UE may then monitor, based on the BFRS detection signal, a beam failure reference signal that is periodic, semi-persistent, or aperiodic.

A wireless terminal apparatus may monitor a beam failure reference signal within a time window. Such a window may be configured by a BFRS detection signal, or by other means, e.g., where no BFRS detection signal is used. The apparatus may determine, based on measurements during the time window, for example that a beam failure instance has occurred.

BFRS detection signals may be sent in a number of ways. For example, an apparatus may receive multiple BFRS detection signals before a receiving a beam failure reference signal. Multiple BFRS detection signals may be sent from the access point at the same or different times, and at the same or different frequencies.

An apparatus may receive a configuration of a detection signal in a static, semi-static, or dynamic way. Such a configuration may be received via radio resource control messaging (RRC), medium access control-control element (MAC-CE), or downlink control indication (DCI), or by a combination of two of more of RRC, MAC-CE, and DCI.

A wire terminal apparatus may track missed beam failure reference signal instances, e.g., by maintaining a count of such missed instances. The apparatus may also report, e.g., via higher layer signaling, the count of missed beam failure reference signal instances to a serving access point. Such reporting may occur, for example when a count of missed beam failure reference signal instances exceeds a configured threshold.

The access point may send a BFRS absence indication to the apparatus to signal that an instance of a beam failure reference signal was not transmitted, or will not be transmitted, due to channel unavailability. The apparatus may then exclude the instance of the beam failure reference signal from the count of missed beam failure reference signal instances.

The apparatus may send, based on the count of missed beam failure reference signal instances, a beam failure recovery request.

The apparatus may receive an access point response detection signal that indicates that the access point has acquired the channel for downlink transmission, and may .monitor an access point downlink transmission based at least in part on the access point response detection signal. The apparatus may trigger timer after receiving an access gNB response detection signal.

For example, an access point may send beam failure reference signals, beam failure reference signal detection signals, and responses to beam failure recovery requests. An access point may also send beam failure reference signal absence indications. The access point may send such signals in multiple ways and on multiple occasions, just at the terminal apparatus may receive multiple instances of the signals. For example, the access point may send multiple beam failure reference signal detection signals before each beam failure reference signal. Again, multiple beam failure reference signal detection signals may be sent at the same or different times or the same or different frequencies. The access point may send a configuration of a detection signal in a static, semi-static, or dynamic way, and may do so, for example, via radio resource control messaging (RRC), medium access control-control element (MAC-CE), downlink control indication (DCI), or two more of RRC, MAC-CE, and DCI.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

A more detailed understanding may be had from the following description, given by way of example in conjunction with the accompanying drawings. The drawings are not necessarily drawn to scale.

FIGS. 1-4 are system diagrams illustrating four example Licensed-Assisted Access (LAA) deployment scenarios.

FIG. 5 is a timing diagram of an example detection signal based serving cell beam failure RS.

FIG. 6 is a timing diagram of an example of detection signal based serving cell beam failure RS at the beginning of Maximum Channel Occupancy Time (MCOT).

FIG. 7 is a timing diagram of an example of window-based serving cell beam failure Reference Signal (RS).

FIG. 8 is a timing diagram of an example of hybrid window-detection signal based serving cell beam failure RS.

FIG. 9 is a timing diagram of an example of failed Listen Before Talk (LBT) indication.

FIG. 10 is a timing diagram of an example of failed LBT indication using Synchronization Signal Block (SSB).

FIG. 11 is a timing diagram of an example of FDM/TDM options of BFRS and SSB.

FIG. 12 is a timing diagram of an example of aperiodic serving cell beam failure reference signal (BFRS).

FIG. 13 is a timing diagram of an example of monitoring window configurations.

FIG. 14 is a timing diagram of an example of different monitoring window configurations using duration list.

FIG. 15 illustrates an example semi-statically configured monitoring window.

FIG. 16 illustrates an example dynamically configured monitoring window.

FIG. 17 is a time and spectrum diagram of an example of configuring Serving Cell Beam Failure Reference Signal (BFRS) detection signal.

FIG. 18 is a time and spectrum diagram of an example of configuring BFRS detection signal with MCOT parameter.

FIG. 19 is a time and spectrum diagram of an example of transmit BFRS detection signal using time diversity.

FIG. 20 is a time and spectrum diagram of an example of transmit BFRS detection signal using frequency diversity.

FIG. 21 is a time and spectrum diagram of an example of transmit BFRS detection signal using time-frequency diversity.

FIG. 22 is a time and spectrum diagram of an example of window-based BFRQ

FIG. 23 is a timing diagram of an example window-based BFRQ on multiple beams.

FIG. 24 illustrates an example BFRQ transmission timer and counter configuration.

FIG. 25 illustrates an example BFRQ transmission timer and/or counter configurations using RRC+MAC-CE+DCI

FIG. 26 is a timing diagram of an example BFRQ through BF channel occupation indicator

FIG. 27 is a timing diagram an example indication based gNB response.

FIG. 28 is a timing diagram an example window-based gNB indicator.

FIG. 29 is a timing diagram an example transmitting gNB response on multiple candidate beams.

FIG. 30 is a timing diagram an example multi-beam window-based gNB response indicator.

FIG. 31 illustrates an example communications system.

FIG. 32 is a block diagram of an example apparatus or device configured for wireless communications such as, for example, a wireless transmit/receive unit (WTRU).

FIG. 33 is a system diagram of a first example radio access network (RAN) and core network.

FIG. 34 is a system diagram of a second example radio access network (RAN) and core network.

FIG. 35 is a system diagram of a third example radio access network (RAN) and core network.

FIG. 36 is a block diagram of an exemplary computing system in which one or more apparatuses of communications networks may be embodied, such as certain nodes or functional entities in the RAN, core network, public switched telephone network (PSTN), Internet, or other networks.

### DETAILED DESCRIPTION

ABBREVIATIONS

| BFRS | serving cell beam failure reference signal |
|---|---|
| BF_RS_absence_ | BFRS absence radio network temporary identified |
| RNTI | |
| BF_RS_triggering_ | BFRS triggering radio network temporary identifier |
| RNTI | |
| BFRQ_Tx_RNTI | BFRQ-Tx-counter-radio-network temporary identifier |
| BFRQ_Tx_ | BFRQ-Tx-timer-radio-network temporary identifier |
| timer_RNTI | |
| CA | Carrier aggregation |
| CCA | Clear channel assessment |
| CORESET | Control resource set |
| C-RNTI | Cell Radio-Network Temporary Identifier |
| DC | Dual connectivity |
| DCI | DL Control Information |
| DL | Downlink |
| DL-RS | Downlink reference signal |
| gNB-Resp-DS | gNB response detection signal |
| LAA | Licensed-assisted access |
| LBT | Listen Before Talk |
| LTE | Long Term Evolution |
| MAC | Medium Access Control |
| MCOT | Maximum Channel Occupancy Time |
| Mon_wind_RNTI | Mon_wind_radio network temporary identified |
| NR | New Radio |
| NR-U | New radio unlicensed |
| OFDM | Orthogonal Frequency Division Multiplexing |
| Pcell | Primary cell |
| PDCCH | Physical Downlink Control Channel |
| PHY | Physical Layer |
| PSS | Primary synchronization signal |
| PUCCH | Physical uplink control channel |
| PUSCH | Physical uplink shared channel |
| QoS | Quality of Service |
| RAN | Radio Access Network |
| RRC | Radio Resource Control |
| RS | Reference signal |
| SCells | Secondary cells |
| SSB | Synchronization signal block |
| SSS | Secondary synchronization signal |
| UE | User Equipment |
| UL | Uplink |

### Unlicensed Spectrum in NR

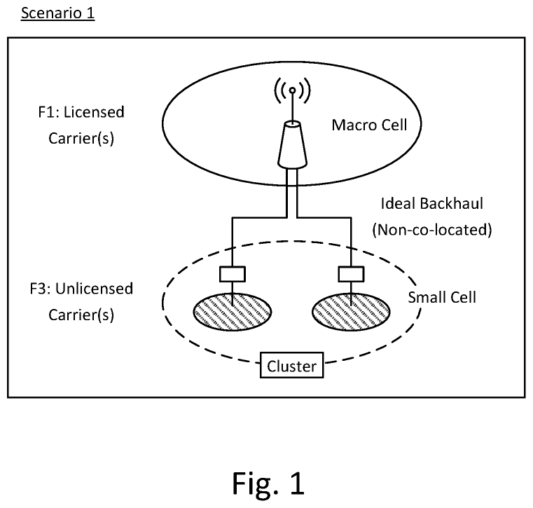

As specified in 3GPP TS 36.213, Physical Layer Procedures, for Release13 and Release 14, Licensed-assisted access (LAA) targets the carrier aggregation (CA) operation in which one or more low power secondary cells (SCells) operate in unlicensed spectrum in sub 6 GHz. LAA deployment scenarios encompass scenarios with and without macro coverage, both outdoor and indoor small cell deployments, and both co-location and non-co-location (with ideal backhaul) between licensed and unlicensed carriers, as shown in FIGS. 1-4.

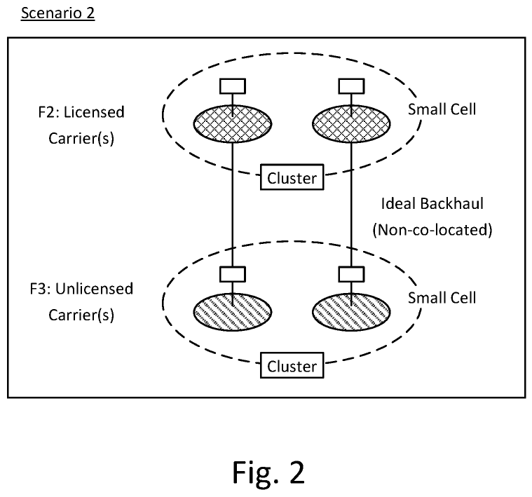

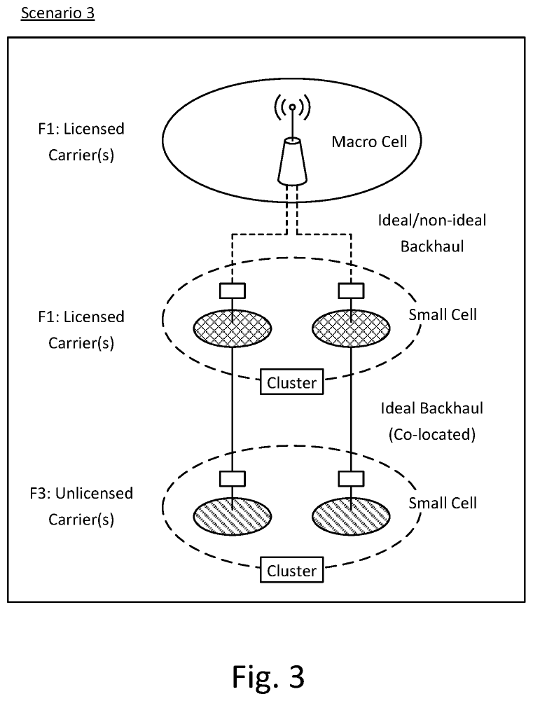

In Scenario 1 of FIG. 1 depicts carrier aggregation between licensed macro cell (F1) and unlicensed small cell (F3). Scenario 2 of FIG. 2 depicts carrier aggregation between licensed small cell (F2) and unlicensed small cell (F3) without macro cell coverage. Scenario 3 of FIG. 3 depicts a licensed macro cell and small cell (F1), with carrier aggregation between licensed small cell (F1) and unlicensed small cell (F3).

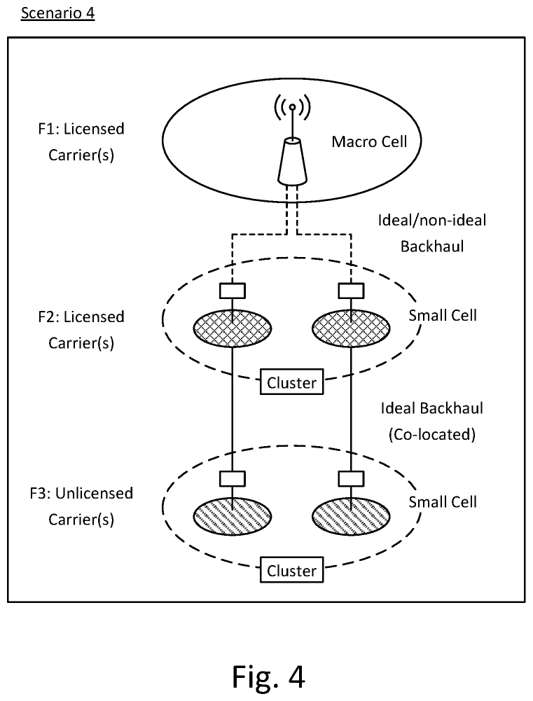

Scenario 4 of FIG. 4 depicts a licensed macro cell (F1), licensed small cell (F2), and unlicensed small cell (F3). Scenario 4 includes carrier aggregation between licensed small cell (F2) and unlicensed small cell (F3). If there is ideal backhaul between macro cell and small cell, there can be carrier aggregation between macro cell (F1), licensed small cell (F2) and unlicensed small cell (F3). If dual connectivity is enabled, there can be dual connectivity between macro cell and small cell.

Since unlicensed band can be utilized by different deployments specified by different standards, several regulatory requirements are imposed to insure fair coexistence between all incumbent users. For example, these regulatory requirements include constraints on transmit power mask, transmit bandwidth, interference with weather radars, etc.

Another main requirement is channel access procedure. The LBT procedure is defined as a mechanism by which an equipment applies a clear channel assessment (CCA) check before using the channel. The CCA utilizes at least energy detection to determine the presence or absence of other signals on a channel in order to determine if a channel is occupied or clear, respectively. European and Japanese regulations mandate the usage of LBT in the unlicensed bands. Apart from regulatory requirements, carrier sensing via LBT is one way for fair sharing of the unlicensed spectrum and hence it is considered to be a vital feature for fair and friendly operation in the unlicensed spectrum in a single global solution framework.

In Release 14, several channel access procedures are introduced to be performed by eNB and UE for both downlink (DL) and UL transmissions, respectively. The main channel access procedure is described in Section 15 of TS 36.213 Release 14.

### Unlicensed Spectrum in NR

In mmWave, there is wide range of unlicensed spectrum that can be further utilized to attain higher data rate than attained by operating in sub 6 GHz frequency band. Consequently, in RAN #76 a new SI for NR based access to unlicensed spectrum was introduced. See RP-172021, “New SID on NR-based Access to Unlicensed Spectrum”, Qualcomm. The main goals of the current SI include studying the different physical channels and procedures in NR-U and how they have to be modified or even introduce new physical channels or procedures to cope with NR-U challenges and take into account the main feature of operating in mmWave which is deploying narrow beams for transmission and reception above 6 GHZ up to 52.6 GHz or even above 52.6 GHz bands. Procedures to enhance the co-existence between NR-U and other technologies operating in the unlicensed, e.g., WiFi devices, LTE-based LAA devices, other NR-U devices, etc., and meet the regulatory requirements will be extensively studied. For more details, please refer to RP-172021.

### Beam Failure Recovery in NR

In Section 6 of TS 38.213 Release 15 V15.1.0, a detailed beam failure recovery (BFR) procedure is described for a single cell. The essence of developed BFR procedure is to recover the failed beams due to UE movement, rotation, blockage, etc., as prompt as possible through lower layers such as physical (Phy) and medium access control (MAC) layers, e.g., L1/L2, to avoid the tremendous delay due to higher layers if they are involved in the beam recovery procedure.

### Challenges

Recently, there is an increasing discussion on supporting BFR on secondary cell(s) (Scells) in carrier aggregation deployment (CA) and primary Scell (PScell) in dual connectivity deployment for the licensed frequency bands. Therefore, it is of great interest to study the deployment of BFR procedure for an unlicensed carrier because it is expected that Scell, PScell, or even standalone unlicensed carrier, may operate in mmWave frequency range and they may even be more vulnerable to beam failure.

Operating on the unlicensed carrier imposes additional challenge because the regulator requirements oblige each node to perform channel sensing, called listen-before-talk (LBT), before attempting to access the channel to avoid colliding and interfering with any concurrent transmission. The LBT deployment introduces additional uncertainty in the presences of any transmission. In other words, any configured or scheduled transmission may not occur due to channel unavailability which may detrimentally affect beam failure recovery procedure. In this paper, we address the challenges associated with the deployment of beam failure recovery procedure in an unlicensed carrier.

### Problem 1: Br Measurement Reliability

Deploying LBT, imposed by regulatory requirements, introduces uncertainty on whether the signal is transmitted in deeply faded channel or it is not transmitted due to channel unavailability. This raise a question on how to handle the measurements for BFR in NR-U for CA, DC and standalone. Specifically, how to increase the transmission chance of the serving cell beam failure reference signal that the UE measures to quantify the beam quality and determine whether beam failure should be declared or not such as channel state information reference signal (CSI-RS), synchronization signal block (SSB), etc. How to allow the UE to distinguish between the absence of the serving cell beam failure reference signal and their transmission over deeply faded beam. What the UE behavior upon the absence of serving cell beam failure reference signal.

### Problem 2: Beam Failure Recovery Request Transmission

Upon identifying beam failure, the UE may send beam failure recovery request. However, due to the mandated LBT, UE may fail to access the channel due to its unavailability. Issues include: how such situation may be handled; how to increase the opportunity of beam failure recovery request transmission; and how should the UE behave while the beam is failed but the channel is unavailable to transmit the beam failure recovery request.

### Problem 3: Monitoring gNB Response

In the last stage of the beam failure recovery procedure, the UE has to monitor the gNB response to determine whether procedure is completed successfully or not. In an unlicensed band, gNB may fail to transmit its response. How the UE should behave. How to increase the chance of successful transmission of the gNB response.

### Example Techniques

Beam failure recovery (BFR) may be performed on an unlicensed carrier via solutions deployed, for example, for non-standalone unlicensed NR such as single or multiple secondary cells (Scells) when carrier aggregation (CA) is configured and primary Scells (PScells) when dual connectivity (DC) architecture, or even for standalone unlicensed NR.

### Measurement Procedures for Declaring Beam Failure

In NR-U, several measurement procedures may be performed to declare beam failure when the measurement quality is less than certain threshold.

### Procedures to Enhance Measurements Reliability

In an unlicensed carrier, gNB has to perform listen-before-talk (LBT) prior each channel access attempt which imposes uncertainty on whether the reference signals (RSs), for example, channel state information reference signal (CSI-RS), synchronization signal block (SSB), etc., used for beam failure assessment are transmitted or not. In such situation, when UE detects that RS quality is less than certain threshold, it may not be able to determine the true reason for the degraded measurement quality which may be beam failure recover RSs are transmitted and beam failure should be declared due to blockage, UE rotation, etc., or serving cell beam failure RSs are not transmitted due to failed LBT at the gNB side.

### Detection Signal Based Serving Cell Beam Failure RS

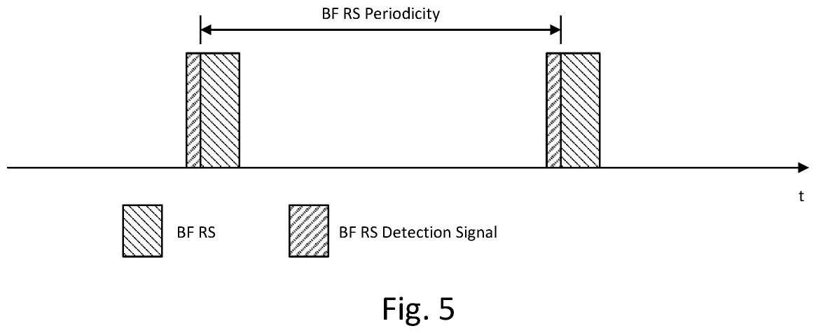

To allow the UE to distinguish among reasons for poor serving cell beam failure RS (BFRS) measurements, e.g., experiencing highly faded beam or BFRSs are not transmitted due to channel unavailability at gNB, a signal such as BFRS detection signal may be used to assist the UE to recognize the presence or the absence of BFRS. BFRS detection signal may be sequence or special patterns that may be identified by a single UE or multiple UEs in case that BFRSs are configured for them. As shown in FIG. 5, prior to each BFRS transmission, gNB may transmit BFRS detection signal. If UE successfully recognizes the BFRS detection sequence or patterns, then it may assume that BFRS is transmitted by gNB. If the measurements quality is less than certain threshold then the physical (Phy) layer reports this beam failure instance to the higher layer. On the other hand, if BFRS detection signal is not recognized by the UE, then no beam failure instance is reported to the higher layer, the UE may indicate the absence of BFRS to the higher layer instead.

We introduce BFRS absence counter that may be configured in higher layers to count the number of instances in which gNB fails to access the channel. Upon exceeding certain threshold, the UE may transmit beam failure recovery request (BFRQ) or start radio link failure procedure.

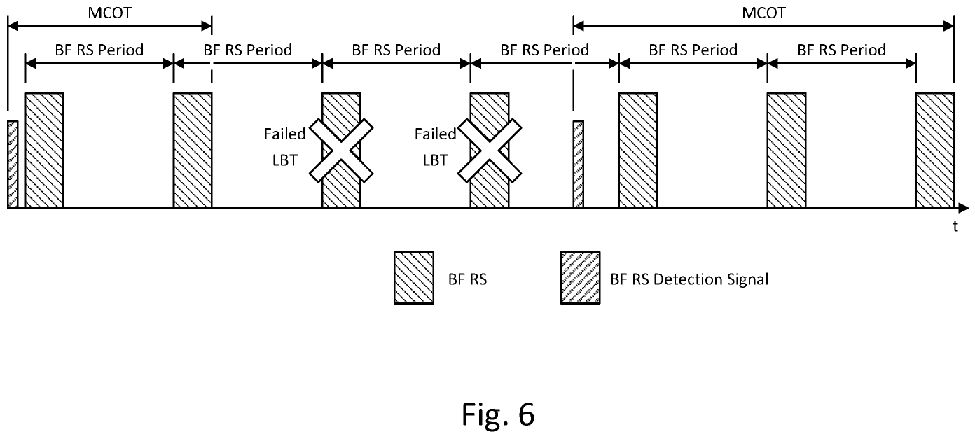

Alternatively, BFRS detection signal may be transmitted at the beginning of the MCOT, e.g., once gNB successfully performs LBT, it may transmit BFRS detection signal to all UEs supposed to monitor BFRS as illustrated in FIG. 6, for example. Specifically, if the UE fails to identify the BFRS detection signal, it may assume that all the configured BFRS until the next BFRS detection signal are absent. In this case, it may increase the BFRS absence counter until the next BFRS detection signal. As shown in FIG. 6, the UE may utilize the first BFRS detection signal to perform measurements in the first two configured BFRS. Then it may count the 3^{rd} and 4^{th} BFRSs as absent resources until it receives the 2^{nd} BFRS detection signal. Specifically, BFRS detection signal may convey information about the MCOT duration and, hence, the UE may be aware of the number of BFRS that is guaranteed to be transmitted and the number of the absent BFRS. The BFRS counter is reset upon identifying BFRS detection signal again.

### Window-Based Serving Cell Beam Failure RS

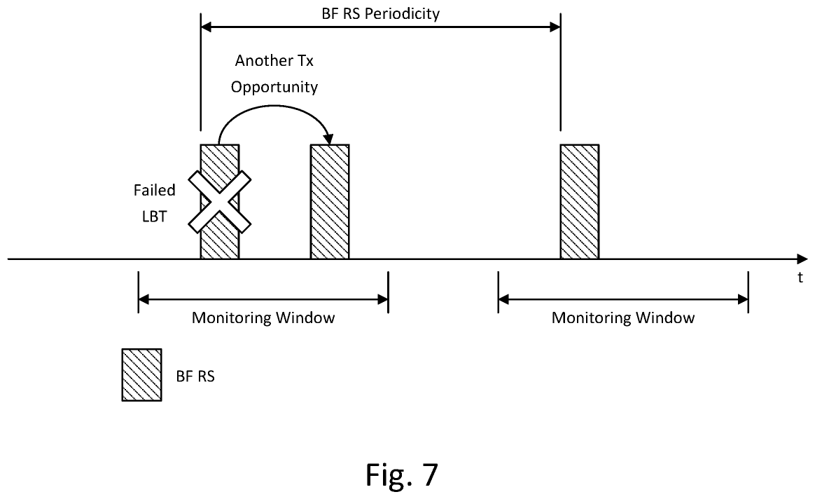

Instead of configuring the UE to monitor BFRS in predefined instances that may be periodic, semi-persistent, or aperiodic, it may be configured to monitor a time window instead. As illustrated in FIG. 7, for example, the UE may be configured with periodic BFRS and each transmission instance may occur anywhere within monitoring window. In case that gNB unsuccessfully performs LBT prior to BFRS transmission, e.g., the channel is not idle and occupied by other nodes, then it may attempt to access the channel e.g., perform another LBT, until the channel is idle and BFRS is transmitted or until the end of the monitoring window.

In this procedure, the UE keeps monitoring BFRS during the entire monitoring window. A decision on declaring beam failure instance may be done based on the best measurements during the entire monitoring window.

### Hybrid Window-Detection Signal Based Serving Cell Beam Failure RS

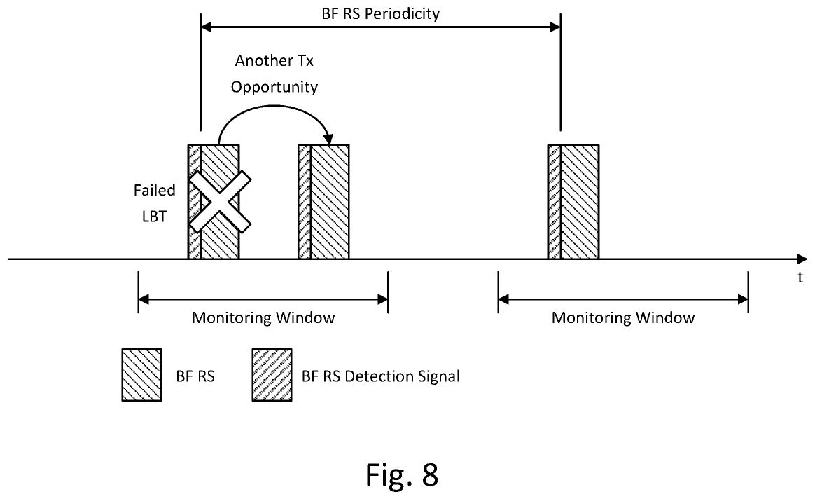

To further increase the chance of transmitting BFRSs and enhance their detectability, detection signal and window based transmission may be used. In this method, UE may search for the BFRS detection signal across the entire monitoring window. If the UE successfully recognize the BFRS detection signal, then it proceeds assessing the quality of the beam and declare beam failure instances to the higher layer when the measurements quality is less than particular threshold as illustrated in FIG. 8.

On the other hand, if the UE does not recognize the BFRS detection signal within the monitoring window, it reports BFRS absence to the high layer.

BFRS detection signal may be transmitted within the monitoring window at the begging of the COT whenever gNB successfully acquires the channel. It may indicate the COT duration to the UE. In turn, the UE may assume that all BFRS within the COT will be transmitted.

### Failed LBT Indication

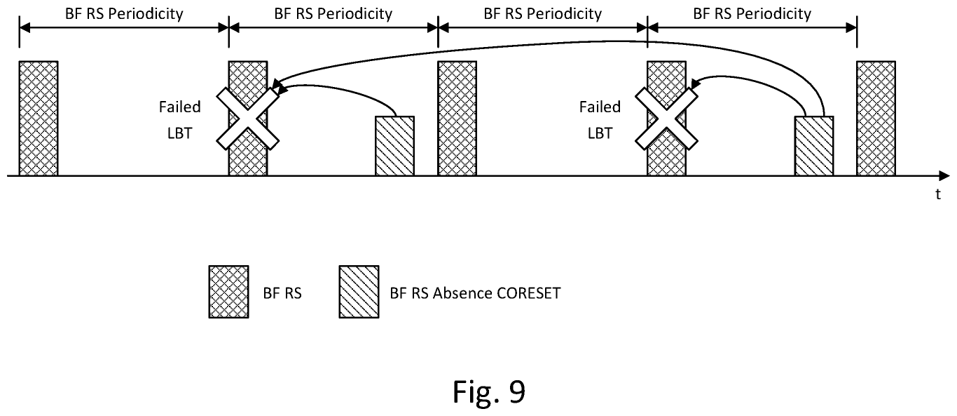

An explicit indication of the number of BFRS indices/instances which the gNB fails to transmit due to unsuccessful LBT may be used. Hence, the UE may not report the beam failure instance to high layer and avoid declaring false beam failure event. A BFRS absence CORESET may be configured to be monitored by the UE only when beam failure instance is reported to the higher layer. The BFRS absence CORESET may be configured before the transmission of the new BFRS to increase the chance of channel availability if the channel is not idle for previous BFRS, as shown in FIG. 9. As shown in FIG. 9, BFRS absence CORESET may be configured after each BFRS or after multiple BFRS.

BFRS absence CORESET may be spatial QCL'ed to BFRS of the same beam before transmitting beam failure recovery request. BFRS absence CORESET may be spatial QCL'ed with BFRS of the UE identified candidate beam in the beam failure recovery request. BFRS absence PDCCH may be transmitted in the dedicatedly configured beam failure recovery response CORESET without introducing a new CORESET.

If BFRS absence PDCCH_A0, for example, is transmitted after the failed BFRS and before the transmission of the new BFRS, then its DCI may contain BF_RS_absence_indicator 1-bit field to indicate that the previous BFRS is not transmitted due to channel unavailability and beam failure instance should not reported to the higher layer while BFRS absence counter should be increased by one.

If BFRS absence PDCCH_A1, for example, is used to indicate the absence of multiple BFRS, then its DCI may carry BF_RS_absence_bitmap its size depends on the earliest absent BFRS that may be indicated by BFRS absence PDCCH_A1. For example, in FIG. 9, the bitmap size is equal to three bits and its value may be 101 to indicate the indices of absent BFRS. According to this bitmap, for example, the UE may not report those beam failure instances to the higher layer and increase the BFRS absence by two.

If BFRS absence PDCCH is transmitted within the dedicatedly configured BFRS absence CORESET, then the UE may neither monitor gNB response nor switch to the new candidate beam.

BFRS absence PDCCH may be transmitted on UE-specific search space using its cell radio network temporary identifier (C-RNTI) or it may be transmitted on the common search space. For this purpose, a BFRS absence radio network temporary-identified (BF_RS_absence_RNTI) may be used to signal the absent BFRS indices to multiple UEs which are assigned with BF_RS_absence_RNTI.

Alternatively, this DCI may provide indication on the previous time instances which gNB failed acquiring the channel. For example, this DCI may contain channel_availability_bitmap and its size, denoted by K bits, may be fixed or configurable. Each bit may correspond to single/multiple OFDM symbol, slot, subframe, etc., which may be configurable by high layer signaling, e.g., RRC or RRC plus MAC-CE. Each bit may indicate to the availability of the corresponding time resources assisting the UE to know which BFRS(s) are transmitted. This DCI may be transmitted in UE-specific search space scrambled by C-RNTI or transmitted in a group-common search space such that multiple UEs may receive it. The time duration between any two consecutive occasions may be divided into K durations and the channel availability of each duration may be indicated by one bit. Moreover, this DCI may indicate the channel status starting from particular reference point in the time that may configured by RRC and it may be measured from the DCI, for example.

Since the UE PHY may report the beam failure instance to the UE MAC which counts those instances and then declare beam failure if the number of beam failure instances is greater than certain threshold, indicating those instances to gNB as well is proposed. UE may indicate each beam failure instance to gNB. Or for multiple beam failure instances, the UE may indicate their number instead of one-by-one indication to reduce the overhead. Such indication may be carried by PUCCH or UCI piggybacked UCI on PUSCH, or other UL channels or signals such PRACH, for example. If gNB received such indication for non-transmitted BFRS due to channel unavailability, gNB may signal to the UE that some BFRS are not transmitted through DCI as mentioned above.

DCI may trigger/schedule aperiodic BFRS(s) that UE may use to measure the beam quality in case that gNB fails in transmitting the configured periodic BFRS. The UE may be indicated that the triggered aperiodic BFRS are used to compensate the missing BFRS by RRC configurations of the aperiodic BFRS, DCI, etc. For example, introduce additional bit field in the DCI to indicate that aperiodic BFRS is to compensate the periodic BFRS that gNB failed in transmitting them due to LBT failure. As mentioned earlier, the DCI may carry information on which periodic BFRS(s) are not transmitted due to LBT failure. Alternatively, the RRC configurations of the aperiodic BFRS may carry its usage by introducing a new IE, e.g., usage that may be set to replacement for example. In this case, upon triggering this aperiodic BFRS, then the UE may infer that some BFRS(s) are not transmitted due to LBT failure.

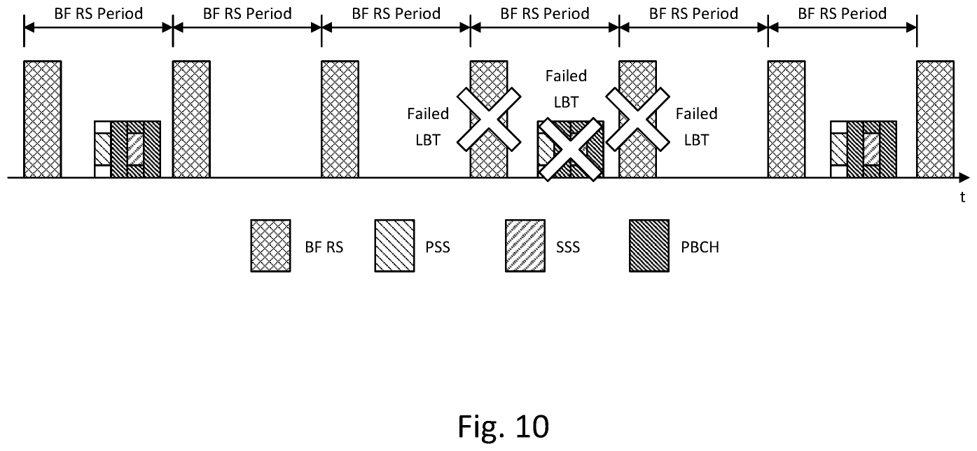

Moreover, the UE may utilize the synchronization signal block (SSB) to infer the number of absent BFRSs. Since both SSB and BFRS are periodic and a UE is expected to monitor both of them, the UE may identify the number of BFRS between any two SSBs. For illustration purposes, FIG. 10 shows three SSBs and the 2^{nd} one is not transmitted due to failed LBT. Hence, it is more likelihood that BFRSs nearby this this SSB are blocked as well, though it is not guaranteed to always be true. The number of BFRSs that may be blocked surrounding the failed SSB may be configurable through high layer parameters such as failed_LBT_window_size, e.g., RRC message, for example. In FIG. 10, failed_LBT_window_size is set to two meaning that the UE may assume one BFRS prior to the blocked SSB and another one after the block SSB are absent. The failed_LBT_window_size may be semi-statically configured by using MAC-CE to select one of the candidate sizes of this window which may be configured by RRC message failed LBT window sizes list, for example.

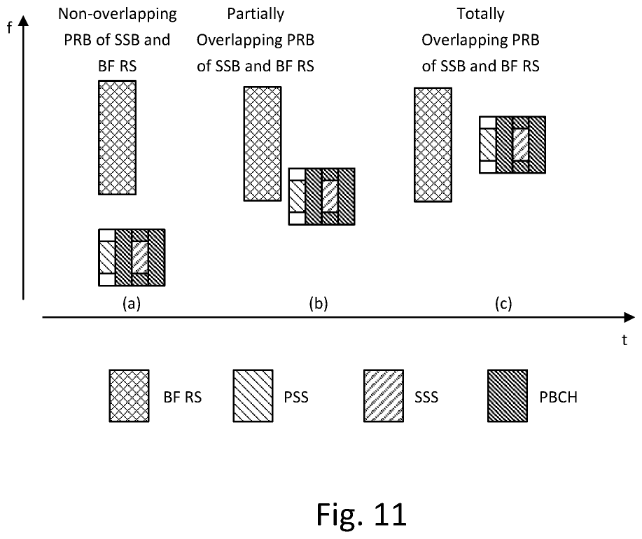

BFRS and SSB may be frequency/time divisions multiplexed (FDMed/TDMed) in several manners. They may occupy non-overlapping physical resource blocks (PRBs) because SSB may occupy narrow band while BFRS occupy wider frequency band and they occupy several overlapped OFDM symbols as shown in FIG. 11 (a). Also, those PRBs may be partially or totally overlapping PRBs while no overlapping between the occupied OFDM symbols as illustrated in FIG. 11 (b) and (c), respectively.

### Aperiodic BFRS

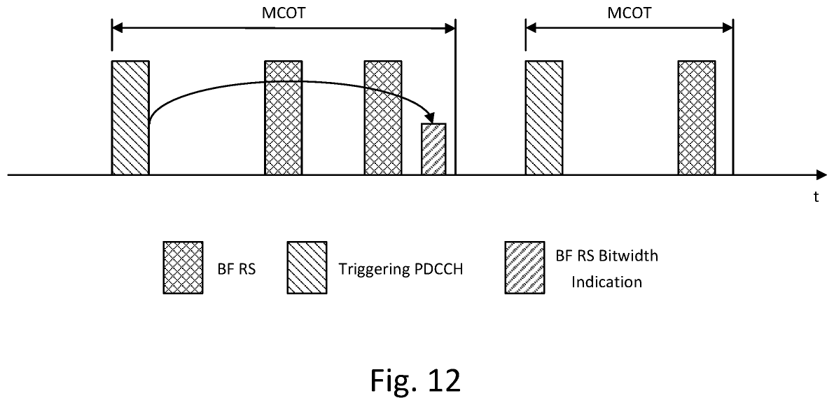

To enhance the detectability of BFRS, and to avoid the ambiguity between the absence of BFRS and experiencing fading beam that requires declaring beam failure, an aperiodic BFRS for beam quality assessment may be configured by the higher layer. Using this technique, a UE may need only monitor aperiodic BFRSs which are triggered by PDCCH, e.g., via DCI format 1_1 for example, and indicated by BFRS trigger field and its bitwidth depends on the number of configured BFRS, as shown in FIG. 12. The bitwidth may be configured by higher layer parameters such as BF_RS_tiggering_bitwidth (e.g. RRC configured), or it may be dynamically signaled through MAC-CE to reconfigure the bitwidth of BFRS trigger field.

Since MCOT may differ from time to time depending on the transmission priority and bitwidth of BFRS trigger field may vary from MCOT to another, the bitwidth of BFRS trigger field in any MCOT may configured or signaled in the previous MCOT. Moreover, we introduce 1-bit field called BFRS bitwidth indication which may indicate whether bitwidth of BFRS trigger field is changed or not to avoid extra power consumption monitoring bitwidth of BFRS trigger field if it is fixed.

As another solution, the bitwidth of BFRS trigger field may assumed to be fixed and equal to the maximum number of BFRSs that may be triggered within the maximum MCOT.

The DMRS of PDCCH carrying BFRS triggering command may be transmitted on UE specific search space using its C-RNTI or common search space. For the latter, we introduce BFRS triggering radio network temporary identifier (BF_RS_triggering_RNTI) to indicate multiple UEs with RNTI to assess the quality of their beams.

gNB may assure that time separation between PDCCH and BFRS is less than or equal the maximum channel occupancy time (MCOT). Moreover, gNB may avoid any time gaps between PDCCH and BFRS to prevent other nodes from grapping the channel while gNB is silent. This may be accomplished by scheduling other UEs during these gaps or even send some reservation data.

At the beginning of MCOT, gNB may transmit reference signal, e.g., DMRS, CSI-RS, PSS, SSS, etc., and/or PDCCH to indicate acquiring the channel successfully, the MCOT duration, the available frequency bands, etc. Such signal and/or channel may trigger aperiodic BFRS in the MCOT duration. To this end, K bits may be signaled to the UE to trigger one potential BFRS(s) and its configurations. A UE may be configured with list of potential BFRS set(s) and its configurations through high layer signaling, e.g., RRC. Each codepoint of the K bits is associated with BFRS set and its configurations. If the number of BFRS set(s) is greater than K bits, then MAC-CE may be used to map up K BFRS set(s) to the K bits. If the signal and/or PDCCH are transmitted to group of UEs, then the index of the triggered BFRS(s) may be obtained as function of each UE ID such as its C-RNTI and signaled K bits.

### Configuration and Signaling for BFR Measurements

To operate in an unlicensed band, regulatory requirements impose performing LBT before access the channel availability to avoid collisions and interference between difference concurrent transmissions. Depending on the outcome of LBT procedure, any transmission may or may not occur. Consequently, such ambiguity, e.g., when it related to the reference signals deployed for beam failure recovery, may be detrimental and lead to false beam failure detection. Certain signals may be useful for such procedures.

### Monitoring Windows

A UE may be configured or signaled the information about the monitoring window through one of the following signaling methods.

### Static Monitoring Window

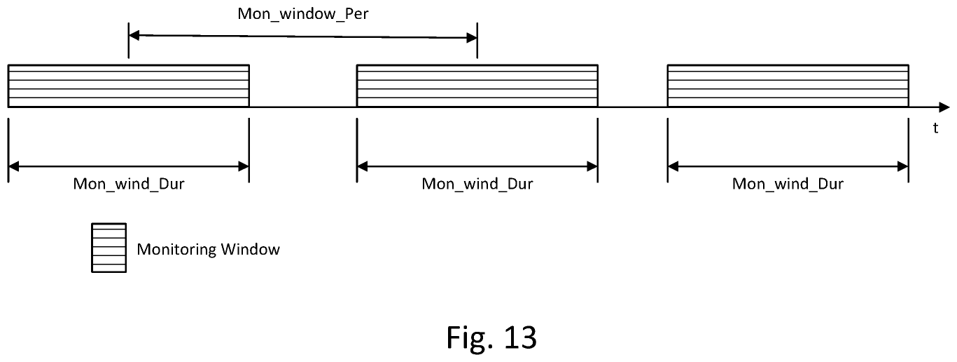

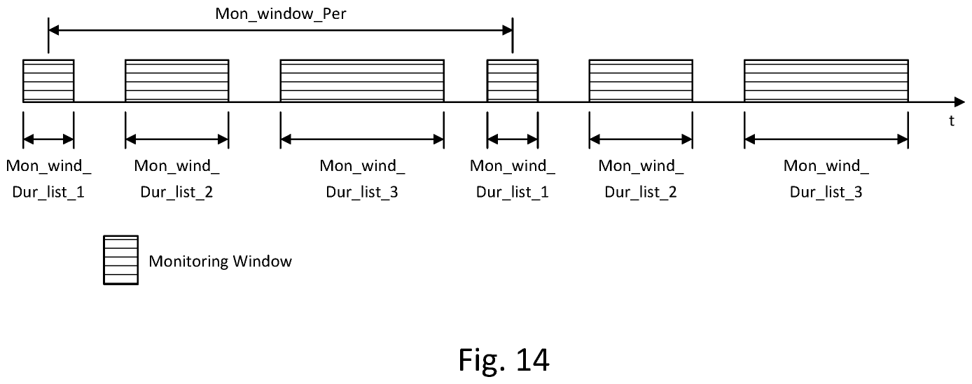

Static monitoring window: In this case, the periodicity and time duration of the monitoring window are configured by high layer parameters such as, for example, Mon_wind_Per and Mon_wind_Dur, respectively, it is RRC configurations, as shown in FIG. 13 for example. It may be a common RRC message or it may be specific RRC message dedicated for a specific UE. Moreover, monitoring windows may have different time durations. They may be configured through high layer parameter such as Mon_wind_Dur list whose entries represent the duration of each monitoring window as illustrated in FIG. 14, for example.

### Semi-Static Monitoring Window:

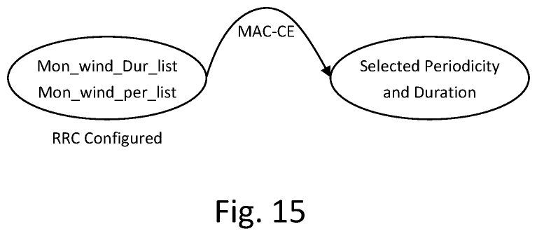

Semi-static monitoring window: Depending on the network status and the unlicensed band loading factor, monitoring window may be reconfigured semi-statically through medium access control-control element (MAC-CE). In this scenario, UE may be configured with multiple monitoring window time durations and periodicities using higher layer parameters, e.g., RRC message, such as Mon_wind_Dur list, defined earlier, and Mon_wind_per_list which consists of a potential periodicity values. Then, MAC CE may be transmitted to select the monitoring window periodicity and time duration as shown in FIG. 15, for example. The DCI carrying the downlink (DL) of MAC CE may be signaled in UE-specific search space using its C-RNTI or it may be signaled, common search space or group common PDCCH with Mon_wind_radio network temporary identified (Mon_wind_RNTI), for example.

### Dynamic Monitoring Window

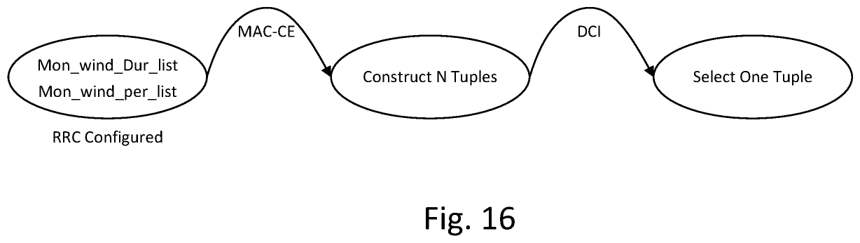

Dynamic monitoring window: For dynamic networks, a DCI to select the monitoring window periodicity and duration may be used. Basically, high layer may configure an N tuples of monitoring window periodicity and time duration, e.g., (period, duration), for example. To this end, we introduce log₂ (N) bits monitoring window tuple field to select one tuple out N configured tuples. Specifically, RRC message may configure lists of candidate duration and periodicity. Then, MAC-CE may be deployed to construct an N tuples and eventually one tuple is triggered through DCI as demonstrated in FIG. 16. This DCI may be transmitted on UE-specific search space using its C-RNTI. Alternatively, it may be transmitted on common search space or group common PDCCH using Mon_wind_RNTI, for example.

### Detection Signal

To enhance the detectability of BFRS and avoid misinterpreting their absence as a deeply faded beam, BFRS detection signal may be used. It may take several forms such as preamble, RS with a certain pattern, etc. For example, it may be DMRS, CSI-RS, SSS, and/or PSS and may be transmitted with particular associated channel, e.g., PDCCH. The essence of BFRS detection signal is that it has to be recognizable with negligible overhead such as simple preamble correlator for example. If the BFRS detection signal is combined with channel, then the UE is not expected to start decoding the associated channel before detecting BFRS detection signal. BFRS detection signal may occupy narrower frequency bandwidth than BFRS to further reduce the UE power consumption while monitoring BFRS detection signal. For example, it may be transmitted in a portion of the operating bandwidth, e.g., a sub-band of the active BWP. Or, BFRS detection signal may occupy wider frequency bandwidth than BFRS to further to take advantage of frequency diversity and enhance its chance to be decoded.

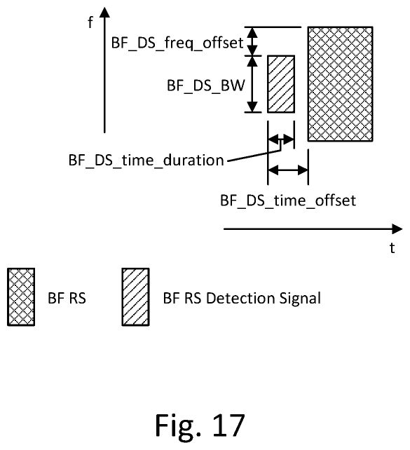

High layer parameters may be used to configure the detection signal type such as BF_RS_detect_type, e.g., RRC configured, that may take value such as preamble, for example. Moreover, the time-frequency resources occupied by BFRS detection signal may be configured by RRC message. For time resources, parameters such as BF_DS_time_offset and BF DS time duration, for example, may be deployed to indicate the beginning of BFRS detection signal from the BFRS and its duration, respectively, as illustrated in FIG. 17, for example. Similarly, for frequency resources, parameters such as BF_DS_freq_offset and BF_DS_BW, for example, may be used to indicate the allocated frequency resources with respect to the BFRS as shown FIG. 17. Moreover, to enhance multiplexing the indication to multiple UEs, the BFRS detection signal may be contiguous or non-contiguous in the frequency domain. It may be transmitted on different ports where each port is dedicated for a group of UEs, for example. Also, different orthogonal covering codes (OCCs) or other covering sequences to dedicate the BFRS detection signal to different UEs' groups.

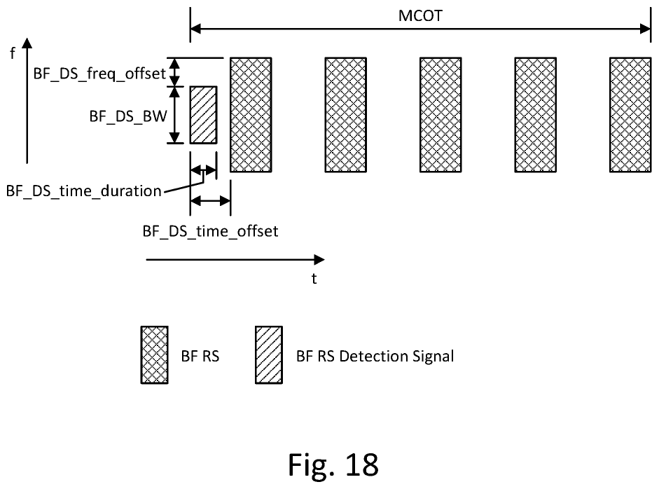

Moreover, BFRS detection signal may be transmitted once the gNB successfully performs LBT and it indicates that multiple BFRS are guaranteed to be transmitted within MCOT window as shown in FIG. 18, for example. In this scenario, MCOT value has to be configured or signaled to the UE. For example, different BFRS detection signals such as preamble or particular signal pattern may be directly mapped to a certain MCOT value. For example, DMRS initialization sequence may indicate the MCOT duration, or the associated PDCCH may indicate the duration of the MCOT and/or the available sub-bands/BWPs. Upon receiving such information, the UE is expected to monitor all the configured BFRS instances within MCOT. Also, MCOT associated with BFRS detection signal may be configured by high layer parameters such as BF_RS_MCOT, for example.

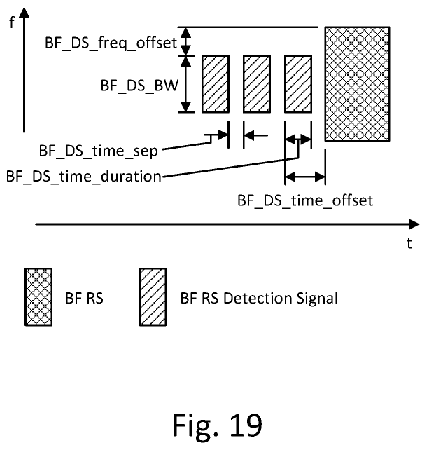

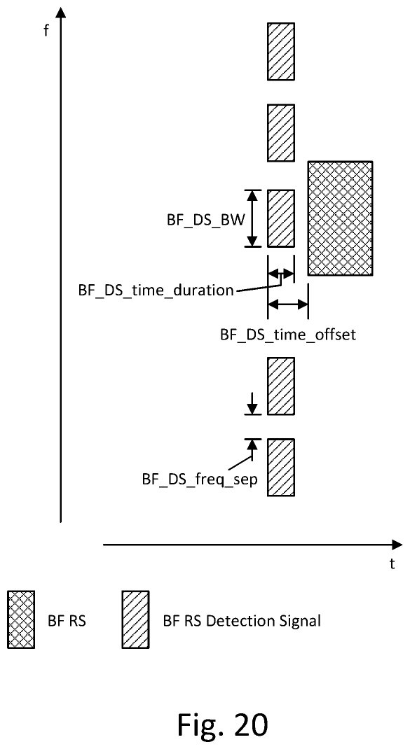

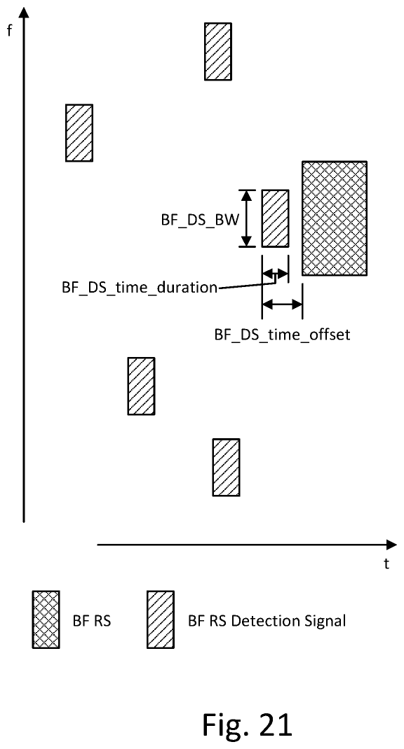

To further increase the robustness of BFRS detection signal, gains in time, frequency, or timer-frequency diversity may be achieved through repeating the BFRS detection signal, transmitting different versions, etc., on different time and frequency resources, as illustrated in FIG. 19, FIG. 20, FIG. 21, respectively. Additional high layer parameters may be introduced to configure the number of BFRS detection signal resources in occasion such as BF_DS_num, e.g., RRC message. BF_DS_time_sep and BF_DS_freq_sep, high layer parameters, may also be introduced to configure the timer and frequency separation between BFRS detection signal resources as shown in Figures FIG. 19 and FIG. 20, respectively. Moreover, to this end, the BFRS detection signal and any associated channel may be even transmitted multiple times after gNB acquired the channel which may be used if the UE fails in detection the signal at the beginning of the MCOT. In this case, the signal may indicate the remaining time duration in the MCOT and also it may indicate the previous portion of the MCOT which the UE missed such that the UE may adjust its counters and averaging.

### Counters

An NR_U beam failure instance counter in the higher layer that may differ from the counter deployed for licensed carrier may be used to increase the robustness against the false beam failure instances. Moreover, due to the UE potential ability to detect the absence of configured BFRS, a BFRS absence counter which may be used to count such instances. Upon exceeding certain threshold, the UE may declare radio link failure (RLF) or it may send beam failure recovery request (BFRQ). The thresholds for these counters may be configured by higher layer parameters such as NRU_BF_cout_th and NRU_BF_absence_count_th, respectively. The values of such counters may be reported to the gNB on PUCCH or UCI piggybacked on PUSCH. Moreover, these values may be transmitted on PUSCH on configured grant. Letting the gNB knows if there is any BFRS transmission instances is counted as absent though it is transmitted by gNB, then gNB may take correction actions such as triggering aperiodic BFRS. Also, this may serve as implicit indication of hidden nodes around the UE, e.g., gNB acquired the channel, but the UE is unable to detect the BFRS detection signal and any associated channel. The value of such counters may be reported on the Pcell, for example.

### Other Configurations

Other high layer configurations may be adopted to overcome LBT effects. For example, the number of measurement samples may be configured differently in NR-U to increase the chance for the UE to collect more samples. Moreover, with the assistance of BFRS detection signal for the UE to determine whether BFRSs are transmitted or not, or any other methods, Phy may modify its filter's coefficients to provide more weight for measurement instances in which LBT is performed successfully at the gNB versus those associated unsuccessful LBT due to channel unavailability. Furthermore, for those absent samples due to failed LBT, they may be replaced with some default values or even extrapolated/interpolated those absent measurement samples using the present measured samples.

### Transmission of Beam Failure Recovery Request (BFRQ)

Assuming that BFRS are transmitted properly and UE identifies the need to transmit beam failure recovery request. Hence, the UE has to perform LBT before the BFRQ transmission. If it is configured to be transmitted in particular occasion such as PRACH occasion, for example, but after sensing the channel, the UE realizes is non-idle and being occupied by other nodes, then the UE has to wait to next occasion to transmit its BFRQ. Following are several solutions to address this problem.

### Window Based BFRQ

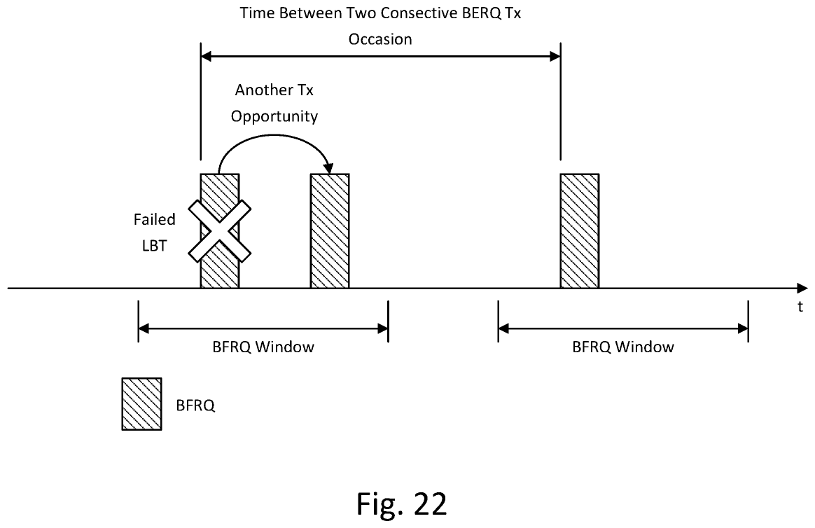

Deploying a BFRQ window instead of single BFRQ Tx occasion may be used, as shown in FIG. 22. This may be achieved by mixture of resources that may be utilized to transmit the BFRQ in the same BFRQ window. For example, it may be a mixture of contention-free PRACH resources surrounded by contention-based PRACH resources. In this case, UE may attempt to transmit either contention-free or contention-based PRACH BFRQ at the same BFRQ window depending on when the channel will be idle. In other word, it is not necessary to only deploy contention-free PRACH-based beam failure recovery request, but also contention-based PRACH may be used.

Moreover, the resources mixture may be PRACH resources, either contention-free or contention-based, and PUCCH uplink resources to transmit the BFRQ which may be signaled by the UL grant DCI, e.g., DCI format 0_1 as an example, or configured by RRC message. Furthermore, the resources mixture may be composed of PRACH resources, either contention-free or contention-based, and uplink MAC-CE resources to transmit MAC-CE message indicating the beam failure. The resources mixture is not limited to the examples stated here, but they are for sake of illustration only.

To further increase the likelihood of transmitted the BFRQ, the capable UE equipped with multiple panels may attempt to transmit the BFRQ on multiple candidate beams not necessary to be only the best one. For example, the UE may perform LBT on multiple candidate beams that satisfy a particular quality threshold and send the BFRQ on the beam associated with successful LBT beam even if it is not the best beam.

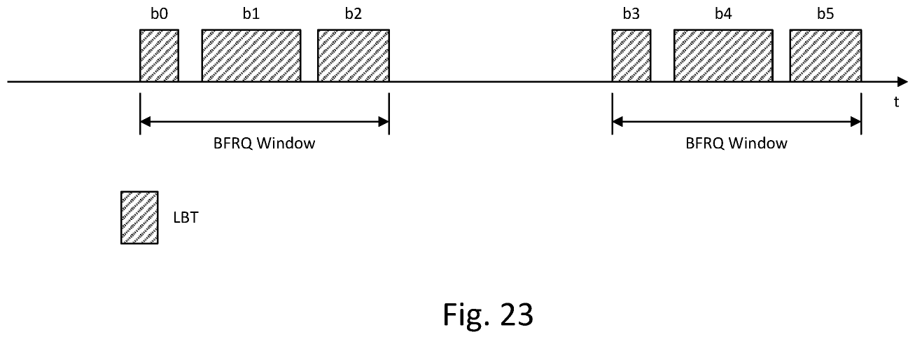

Also, UE may simultaneously transmit BFRQ on multiple beams associated with successful LBT beams to further increase the robustness of BFRQ. If the UE is equipped with a single panel and may only operate on a single beam, then it may utilize the BFRQ window to examine different beam. For example, FIG. 23 shows that the UE identifies six candidate beams denoted by the ordered set (b0, b1, b2, b3, b4, b5) where b0 is the best one. Then in the first BFRQ window, the UE performs LBT on the beam associated to b0. If the channel is unavailable on that beam, it proceeds to b1 and performs LBT on the beam associated with b1 and then to the next best beam. Moreover, if the UE sends the BFRQ on particular candidate beam and BFRQ window does not expire yet, then UE may attempt to transmit the BFRQ on more beams as much as BFRQ window permits.

The BFRQ may also be transmitted on cells such as Pcell and/or Scell(s) which UE has access to them other than the cell experiencing beam failure, but UE is unable to transmit BFRQ due to channel unavailability. The BFRQ may carry information about the cell ID and/or the beam failed ID and/or the preferred candidate beam. For example, the BFRQ on other cells may be in the form of RACH and/or MAC-CE and/or PUCCH, etc. Moreover, information about the duration in which the UE is blocked from accessing the channel due to LBT failure may be signaled to the gNB as well. For example, 1 bit field may indicate the channel unavailability duration, e.g., if this field is set to zero, then the channel is blocked for a duration less than particular threshold and vice versa is this field is set to one. The threshold may be configured by high layer signaling, e.g., RRC. Moreover, it may carry information on cell the UE prefer to get the gNB response. For example, if the cell with beam failure has so many hidden nodes around the UE, then it may be better than gNB response transmitted on different cell. It may be the cell which carried the BFRQ or different one as indicated by the UE, for example.

To avoid getting the UE stuck in BFRQ transmission attempts, we introduce BFRQ transmission timer and/or counter. If the channel is unavailable for long period of time or after several channel access attempts, then the UE may declare radio link failure. The timer expiry time and maximum of the counter may be configured by high layer parameters such as BFRQ-transmission-timer and/or max-BFRQ-transmission-counter, e.g., RRC message. These configurations may be broadcast for multiple UEs or unicasted to specific UEs. Also, BFRQ transmission timer and/or counter may be beam specific which may be configured with higher layer parameters such RRC message denoted by BFRQ-transmission-timer-list and/or max-BFRQ-transmission-counter-list. Each list is composed of multiple 2-tuples such as (beam RS ID, timer expiry/maximum counter value). Those parameters are summarized in Table 1.

TABLE 1
RRC parameters to configuring the BFRQ transmission

| RRC parameter | Description |
|---|---|
| BFRQ-transmission- | Expiry time of the channel access |
| timer | attempts to transmit BFRQ |
| max-BFRQ-transmission- | Maximum number of the |
| counter | channel access attempts |
| BFRQ-transmission- | Expiry time of the channel access |
| timer-list | attempts to transmit BFRQ |
| | on different beams |
| | with their IDs |
| max-BFRQ-transmission- | Maximum number of the channel |
| counter-list | access attempts on different |
| | beams with their IDs |

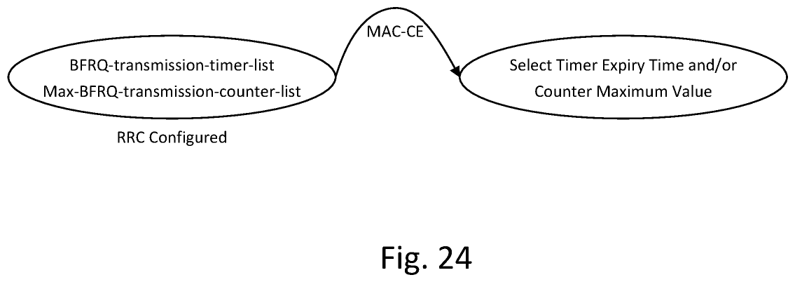

For semi-static networks, MAC-CE may be adopted to signal the expiry timer and/or maximum counter value of the BFRQ transmission timer and/or counter, respectively. Specifically, UEs may be configured with candidate values of the timer expiry time and/or maximum counter value through RRC message, using the parameters in Table 1 for example, and then MAC-CE message may select one value as shown in FIG. 24. The PDCCH carrier the MAC-CE's DL grant may be transmitted on UE-specific search space using its C-RNTI. Alternatively, it may be transmitted on common-search space and group common PDCCH using BFRQ-Tx-timer-radio-network temporary identifier (BFRQ_Tx_timer_RNTI) and/or BFRQ-Tx-counter-radio-network temporary identifier (BFRQ_Tx_RNTI).

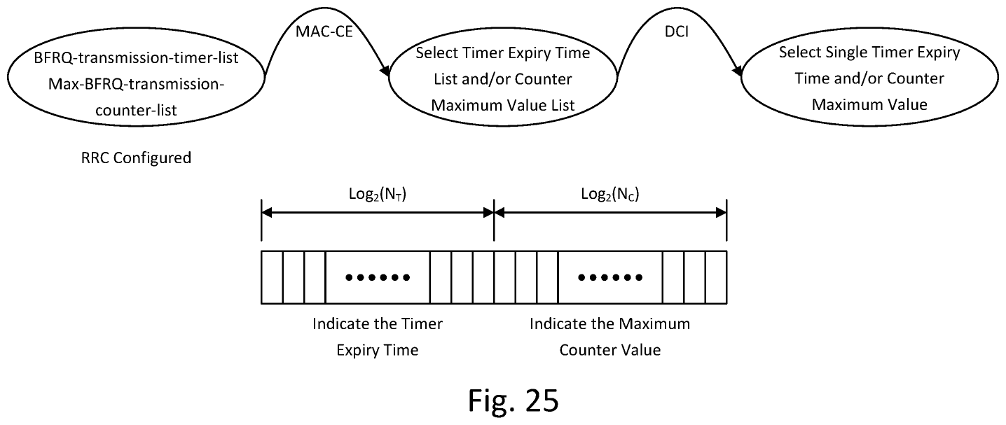

For dynamic networks in which the BFRQ transmission timer and/or counter may be dynamically adjusted, MAC-CE may configure a list of potential expiry times and/or maximum counter value. Each list may consist of N_{T} and N_{C} values. We also propose to use DCI with BFRQ_Tx_field of log₂ (N_{T})+log₂ (N_{C}) where the most significant log₂ (N_{T}) bits may be used to indicate the timer expiry time while the least significant log₂ (N_{C}) bits may be used to indicate the maximum counter value as shown in FIG. 25, for example.

By adopting window based BFRQ transmission, gNB may continuously monitor the UE's BFRQ during this window depending on the resources that may be used to transmit the BFRQ.

### BFRQ Through BF Channel Occupation Indicator

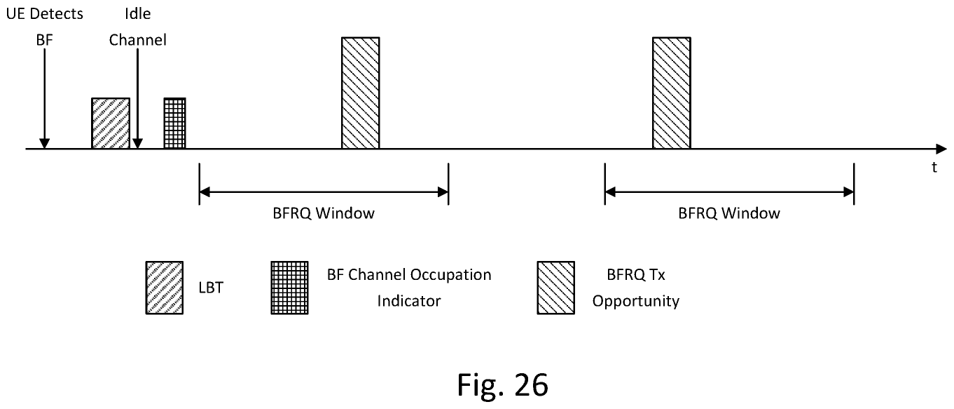

Assuming that the UE detects beam failure before the configured BFRQ transmission window or the single BFRQ transmission opportunity, then UE may perform LBT on the beam associated with the best candidate. It may happen that the UE finds the channel is idle prior to the configured BFRQ transmission window or the single BFRQ transmission opportunity as shown in FIG. 26. Consequently, other nodes may occupy the channel and start transmission while the UE is waiting its BFRQ transmission window or occasion. To cope with this challenge, a UE may send a signal called BF channel occupation indicator on some preconfigured resources to reserve the channel for at least the duration of the BFRQ window. These resources may be more frequent than BFRQ occasions. Moreover, they may be used for other channel usages indicators as well. Some dedicated signals, patterns, RS, etc., may be only used to indicate the BF as illustrated in FIG. 26.

If such signal is detected and successfully decoded by gNB, then UE may not send the BFRQ because it acts as implicit indication of beam failure recovery request. The UE may determine whether this signal may be received by gNB depending on some signal's parameters such as transmission power, sequence, etc. On the other hand, if UE may not guarantee that such signal is decoded successfully at the gNB and it can be received by the neighbor UEs, then those UEs may back off any transmission to allow the UE with failed beam to transmit its BFRQ in the designated transmission opportunity. In this case, BF channel occupation indicator may indicate the duration that other UEs may need to back off.

### Transmitting and Monitoring GNB Response

Moving forward after the transmission of BFRQ, the UE may start monitoring the gNB response. When operating on an unlicensed carrier, gNB has to perform LBT prior to transmitting gNB response. Here the UE may need to distinguish between scenarios. First one is when the gNB finds the channel unavailable and once it is idle, gNB may transmit its response. In the second scenario, gNB is able to occupy the channel, but it does not receive the BFRQ. The following solutions may be used to handle this situation.

### Indication Based GNB Response

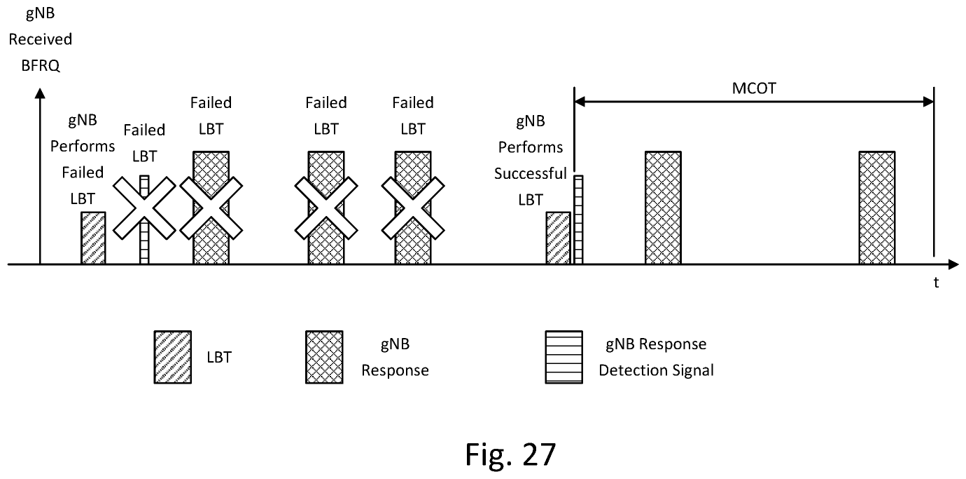

A gNB may transmits an indication signal which is labeled as gNB response detection signal (gNB-Resp-DS). For example, gNB-Resp-DS may be DMRS, SSS, PSS, preamble and it may transmitted with associated channel such as PDCCH. Specifically, once gNB finds that the channel is idle, it may transmit gNB-Resp-DS on preconfigured resources to indicate that it successfully occupied the channel and UE may start monitoring the response, NR-U beam failure CORESET, MAC CE response, etc. FIG. 27 illustrates, for example, that gNB received BFRQ and attempted to transmit a response. Unfortunately, due to channel unavailability, the first three configured occasions for gNB response may not be utilized. Then gNB performs another LBT to attempt access the channel which is successfully completed. Hence, the gNB may transmit gNB-Resp-DS which may be a preconfigured preamble, a signal with a specific structure, etc.

Once the UE detects the gNB-Resp-DS, it may start monitoring the gNB response on the occasions that overlap with the gNB MCOT. Such procedure tremendously reduces the UE power consumption because the UE avoids monitoring gNB response while the channel is unavailable. Basically, UE may perform simple operations to identify gNB-Resp-DS such as preamble correlator, for example, and avoid computationally expensive processes to receive the gNB response such as blind decoding for example.

Consequently, the following timers and/or counters that may be deployed to define the UE behavior. Timer and/or counter to monitor gNB-Resp-DS, for example, they are labeled as gNB-Resp-DS-timer and/or gNB-Resp-DS-counter, respectively, which may be triggered once the BFRQ is transmitted and may be stopped upon receptions/detection of gNB-Resp-DS. The counter will be increased by one for each preconfigured gNB-Resp-DS being absent and not detected.

Upon expiry of gNB-Resp-DS-timer or reaching the maximum of gNB-Resp-DS-counter, UE knows that the channel is unavailable, then the UE may either declare radio link failure, or it may attempt to send the BFRQ on another candidate beam.

Since gNB's response may be transmitted from different cell(s) than the one that has the beam failure, each cell may have different timers/counters and different thresholds as well. For example, if the response is supposed to be transmitted on licensed cell, then these timer/counter are not needed. Also, for different unlicensed cells, different threshold values may be configured depending on the channel occupancy on those cells.

Another timer and/or counter, for example called NR_U-gNB-Resp-timer and NR_U-gNB-Resp-counter, may be introduced to define the UE behavior after detection gNB-Resp-DS. Specifically, NR_U-gNB-Resp-timer and/or NR_U-gNB-Resp-counter may be triggered after the detection of gNB-Resp-DS and they are stopped upon the reception of gNB response. NR_U-gNB-Resp-counter may be increased by one for each configured gNB response occasion that does not carry the gNB response.

Upon expiry of NR_U-gNB-Resp-timer or reaching the maximum of NR_U-gNB-Resp-counter, UE knows that though the channel is idle at the gNB side, no response is transmitted. In this case, the UE may attempt to retransmit the BFRQ on the same beam it used for the previous BFRQ transmission. For example, if UE uses PRACH resources to transmit BFRQ, it may increase the preamble transmission power, use contention-based PRACH, even attempt to transmit the BFRQ using different signal that used in previous transmission, etc.

We also propose a counter to count the number BFRQ transmission on the same candidate beam and we call it same_beam_BFRQ_Tx_counter, for example. This counter may prevent the UE from keep attempting to send the BFRQ on the same candidate beam. Upon the reaching the maximum of same_beam_BFRQ_Tx_counter, the UE may attempt to transmit the BFRQ on different beams or declare radio link failure.

The timers' expiry times and maximum value of the different counters may be configured by high layer parameters such as gNB-Resp-DS-timerEXPIRE, gNB-Resp-DS-counterMAX, NR_U-gNB-Resp-timerEXPIRE, NR_U-gNB-Resp-counterMAX, and same beam BFRQ_Tx_counterMAX, for example.

The UE may be configured or signaled to monitor the gNB-Resp-DS as follows. The UE may assume that gNB-Resp-DS may be spatial QCL'ed with DL RS of the UE identified candidate beam associated with the transmitted BFRQ. If multiple BFRQs associated with multiple candidate beams, the UE may assume the gNB-Resp-DS may be spatial QCL'ed with DL RS of them. Those beams may belong to the same cell with beam failure or other cells if the response is transmitted from them. Moreover, UE may expect that gNB-Resp-DS and any associated channel to be transmitted on UE-specific search space and the details of this search space may be signaled by high layer parameters, RRC messages for example, such as gNB-Resp-DS-periodicity which may indicate the periodicity of gNB-Resp-DS, gNB-Resp-DS-PRB which may indicate the physical resources block (PRB) that may carry gNB-Resp-DS, gNB-Resp-DS-freqOffset which may define the frequency offset from the preconfigured occasions to monitor the gNB response, gNB-Resp-DS-freqBW may configure the BW of gNB-Resp-DS, etc.

Furthermore, the UE may expect that gNB-Resp-DS and any associated channel to be transmitted on common-specific search space and the details of this search space may be signaled by high layer parameters, RRC messages, similar to the aforementioned parameters for example.

The gNB-Resp-DS and any associated channel may be transmitted at the beginning of the MCOT to indicate its duration and other information such as the available sub-band/BWP. This COT can carry other transmissions than gNB response. For example, the COT may contain single or multiple switch points to allow the communication after recovering the link.

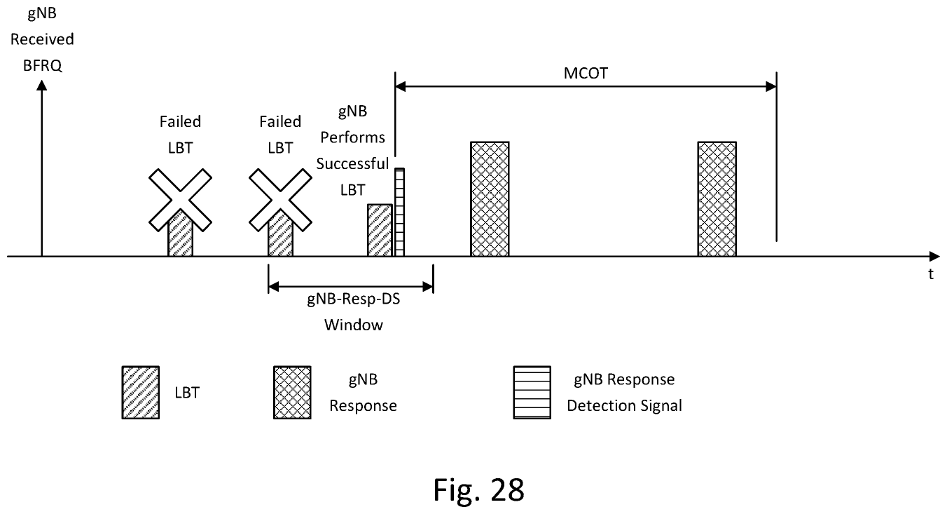

Since the gNB has to perform LBT before the transmission of gNB-Resp-DS, it may be hard to guarantee the channel availability on preconfigured time-frequency resources. The UE may be configured or signaled to monitor in gNB-Resp-DS, instead of just single occasion as illustrated in FIG. 28. To this end, the window size may be indicated by high layer parameters such as gNB-Resp-DS-wind, e.g., RRC message. The gNB-Resp-DS window size may be configured through common RRC message dedicated to multiple UEs or UE specific RRC message.

Moreover, gNB-Resp-DS window may depend on the beam ID. The motivation of this assumption is that each beam may experience different channel occupation factor. Hence, gNB may configure the UE with gNB-Resp-DS-wind, for example, and the beam ID that this monitoring window is associated with by indicating to its spatial QCL′ed DL RS ID. In this case, when UE transmit BFRQ on particular candidate beam, the UE may expect that the gNB-Resp-DS monitoring window to be equal to the one associated with DL RS of the identified beam candidate.

The essence of deploying window-based indicator rather than window based gNB response is that gNB-Resp-DS has lower detection complexity than detecting the gNB response itself which be require several blind decoding attempts for example.

Depending on the nature of gNB-Resp-DS, it may indicate the duration of MCOT, and hence, the number of gNB response occasions that UE is expected to monitor to reduce UE's power consumption.

In the absence of gNB-Resp-DS configurations, defaults configurations may be defined. For example, gNB-Resp-DS-periodicity may be set to equal the periodicity of the gNB response occasions. Also, gNB-Resp-DS-freqOffset may be set to equal zero, while gNB-Resp-DS-freqBW is equal to the BW of the gNB response occasions.

### Increase the GNB Response Transmission Chance

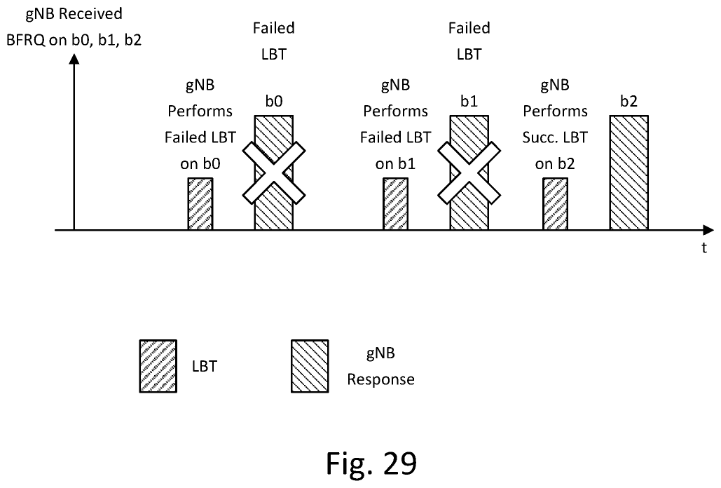

Since UE may transmit BFRQ on multiple candidate beams, as proposed earlier, gNB may transmit its response on those candidate beams identified by the UE. Here the potential spatial, time and frequency diversities are exploited. Since each candidate beam pointing to different directions, there high likelihood that gNB may conduct LBT successfully on one of them. Moreover, since the time-frequency resources configured for gNB response may be different form one beam to another, this adds additional diversity order and increases the chance that gNB response may be transmitted by one of them. For example, FIG. 29 shows that gNB receives the BFRQ on beams b0, b1, and b2, then gNB may perform LBT prior to the transmission occasion on each beam.

The UE expects to receive the gNB response on all the identified candidate beams on the BFRQ. If there are multiple beams with idle channel, then gNB may transmit its response on best candidate beam for the UE. This may be identified by letting the UE to transmit BFRQ in descending order of the candidate beams' RSRP.

### Multi-Beam Window-Based GNB Response Indicator

A gNB response indicator may be detected by a low complexity process such as a simple auto-correlation process. This reduces the consumption of UE resources as compared to monitoring the gNB response on multiple beams via, e.g., several blind decoding attempts.

Moreover, gNB-Resp-DS, defined earlier, may be transmitted within a window to further increase the chance of successful transmission of the gNB response.

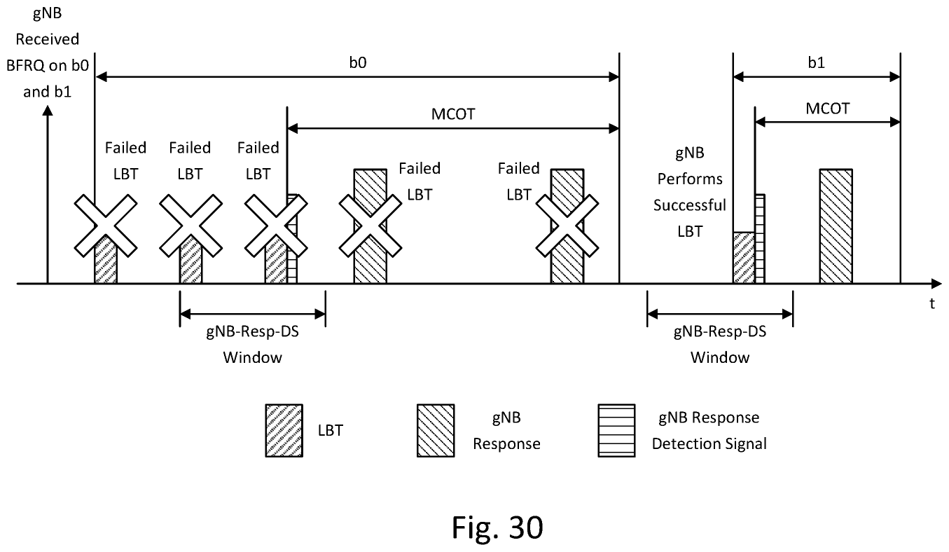

FIG. 30 shows an example when the UE transmits the BFRQ on beams b0 and b1. Moreover, the UE may be configured to monitor the gNB response detection signal. In this case, UE only monitor the gNB-Resp-DS on b0 during the monitoring window associated with this beam. As shown in the figure, the channel on b0 is busy, hence, UE does not waste power in attempting to decode the gNB on the configured occasions. On the other hand, gNB successfully performs LBT on b1 and UE is also monitoring gNB-Resp-DS associated with b1. Once UE detects it, the UE start monitoring the gNB response on the configured occasions on b1.

Most of the configurations on how the UE may send BFRQ on multiple beams, how the UE may monitor the gNB response on multiple beams and how UE may monitor gNB response detection signal and its window, are illustrated earlier.

As mentioned above, BFRS detection signal and gNB response detection signal can be preamble or a signal with low detection complexity. One possible candidate can be demodulation reference signal (DMRS) which can be combined with PDCCH or sent in separately carrying the following information, for example.

The COT duration may be conveyed by the DMRS initialization sequence itself or the combined PDCCH, e.g. DCI format 2_0. The mapping between DMRS initialization sequences and MCOT durations may be configured through high layer such as RRC or MAC-CE, for example. Moreover, the mapping may be pre-configured as well to avoid the configurations overhead.

Moreover, the DMRS by itself or jointly with PDCCH may indicate the available sub-band that BFRS are transmitted on based on LBT outcome. For example, BFRS may be configured over wide frequency bandwidth, e.g., multiple times of LBT bandwidth, then based on LBT outcome, the BFRS may be punctured, and UE shall avoid averaging over the instances in which the channel is unavailable. Alternatively, BFRS may contained in the smallest LBT bandwidth. If the sub-band containing BFRS is not available, then BFRS may not be transmitted and the BFRS absence counter may be increased.

Other signals such as CSI-RS, for example, may indicate that gNB has successfully acquired the channel. This may be indicated by the initialization sequence of CSI-RS, a dedicated CSI-RS port, etc.

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), and LTE-Advanced standards. 3GPP has begun working on the standardization of next generation cellular technology, called New Radio (NR), which is also referred to as “5G”. 3GPP NR standards development is expected to include the definition of next generation radio access technology (new RAT), which is expected to include the provision of new flexible radio access below 6 GHz, and the provision of new ultra-mobile broadband radio access above 6 GHz. The flexible radio access is expected to consist of a new, non-backwards compatible radio access in new spectrum below 6 GHz, and it is expected to include different operating modes that can be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 6 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (e.g., broadband access in dense areas, indoor ultra-high broadband access, broadband access in a crowd, 50+Mbps everywhere, ultra-low cost broadband access, mobile broadband in vehicles), critical communications, massive machine type communications, network operation (e.g., network slicing, routing, migration and interworking, energy savings), and enhanced vehicle-to-everything (eV2X) communications. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, and virtual reality to name a few. All of these use cases and others are contemplated herein.

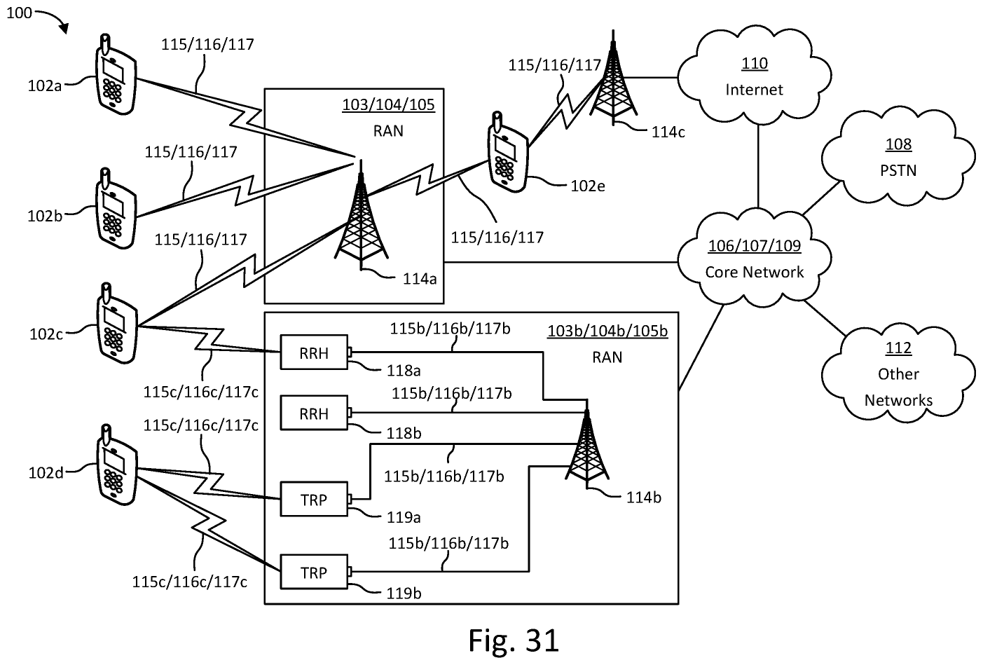

FIG. 31 illustrates one embodiment of an example communications system 100 in which the methods and apparatuses described and claimed herein may be embodied. As shown, the example communications system 100 may include wireless transmit/receive units (WTRUs) 102a, 102b, 102c, and/or 102d (which generally or collectively may be referred to as WTRU 102), a radio access network (RAN) 103/104/105/103b/104b/105b, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d, 102e may be any type of apparatus or device configured to operate and/or communicate in a wireless environment. Although each WTRU 102a, 102b, 102c, 102d, 102e is depicted in FIGS. 31-35 as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, and 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b and/or TRPs (Transmission and Reception Points) 119a, 119b to facilitate access to one or more communication networks, such as the core network 106/107/109, the Internet 110, and/or the other networks 112. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b and/or TRPs 119a, 119b over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b and/or TRPs 119a, 119b may communicate with one or more of the WTRUs 102c, 102d over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b and TRPs 119a, 119b in the RAN 103b/104b/105b and the WTRUs 102c, 102d, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b and TRPs 119a, 119b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology.

In an embodiment, the base station 114a in the RAN 103/104/105 and the WTRUs 102a, 102b, 102c, or RRHs 118a, 118b and TRPs 119a, 119b in the RAN 103b/104b/105b and the WTRUs 102c, 102d, may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 31 may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 31, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 31, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 31 may be configured to communicate with the base station 114a, which may employ a cellular-based radio technology, and with the base station 114c, which may employ an IEEE 802 radio technology.

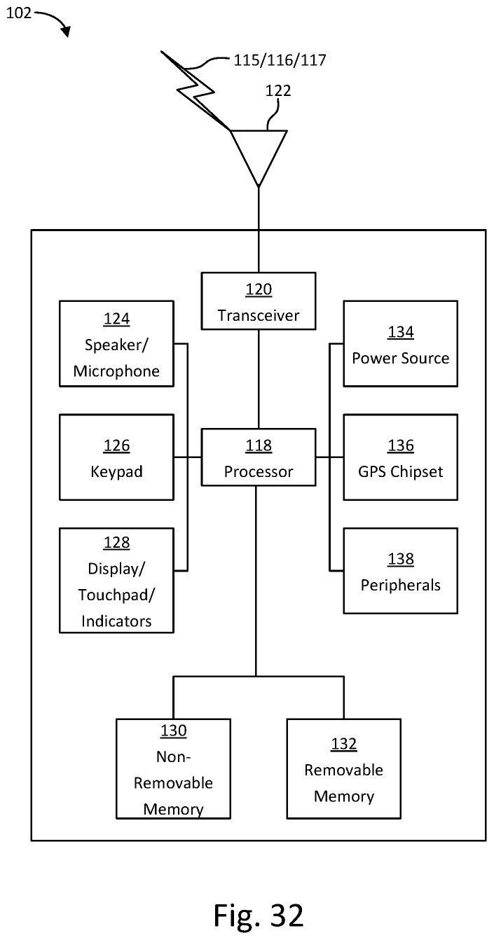

FIG. 32 is a block diagram of an example apparatus or device configured for wireless communications in accordance with the embodiments illustrated herein, such as for example, a WTRU 102. As shown in FIG. 32, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 32 and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 32 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 32 as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

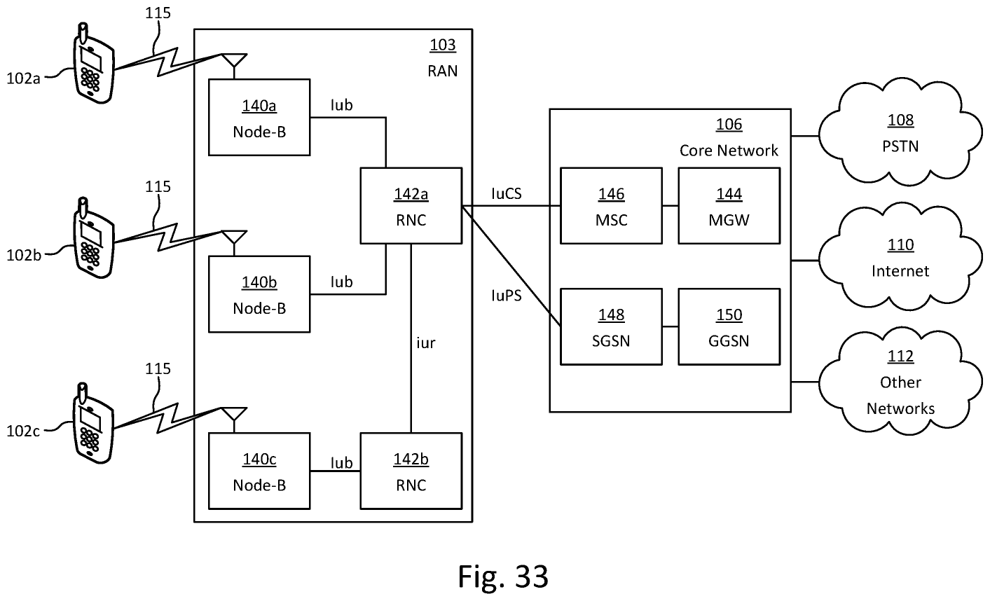

FIG. 33 is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 33, the RAN 103 may include Node-Bs 140a, 140b, 140c, which may each include one or more transceivers for communicating with the WTRUs 102a, 102b, and 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 33, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 33 may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

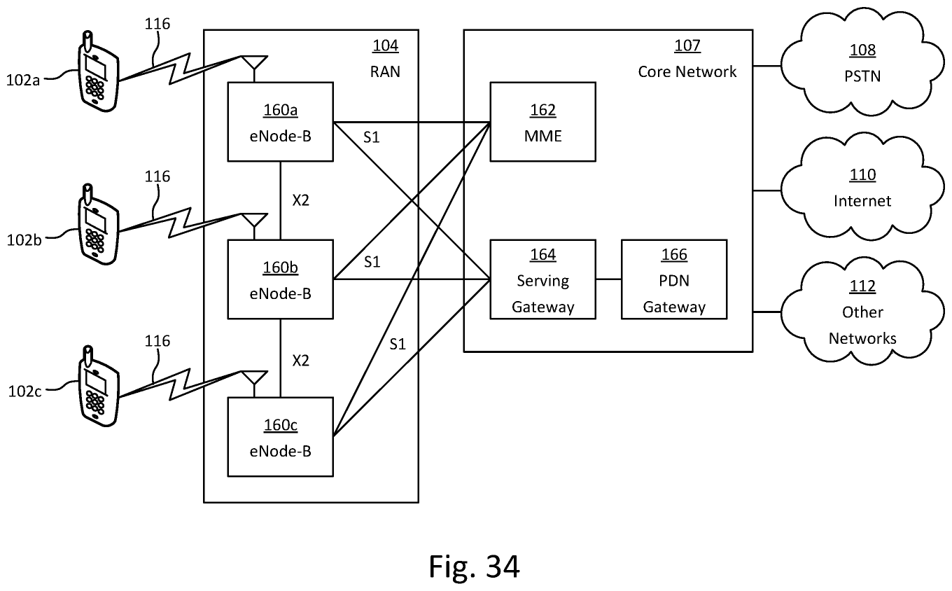

FIG. 34 is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 34, the eNode-Bs 160a, 160b, 160c may communicate with one another over an X2 interface.

The core network 107 shown in FIG. 34 may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the SI interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c, and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

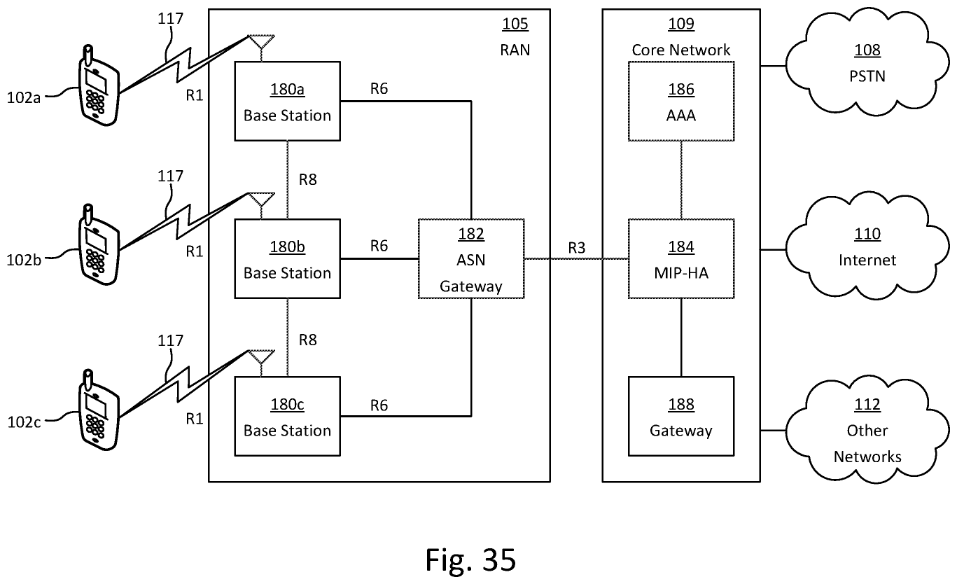

FIG. 35 is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 35, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 35, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c, and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c, and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 35, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 31, 33, 34, and 35 are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 22-26 are provided by way of example only, and it is understood that the subject matter disclosed and claimed herein may be embodied or implemented in any similar communication system, whether presently defined or defined in the future.

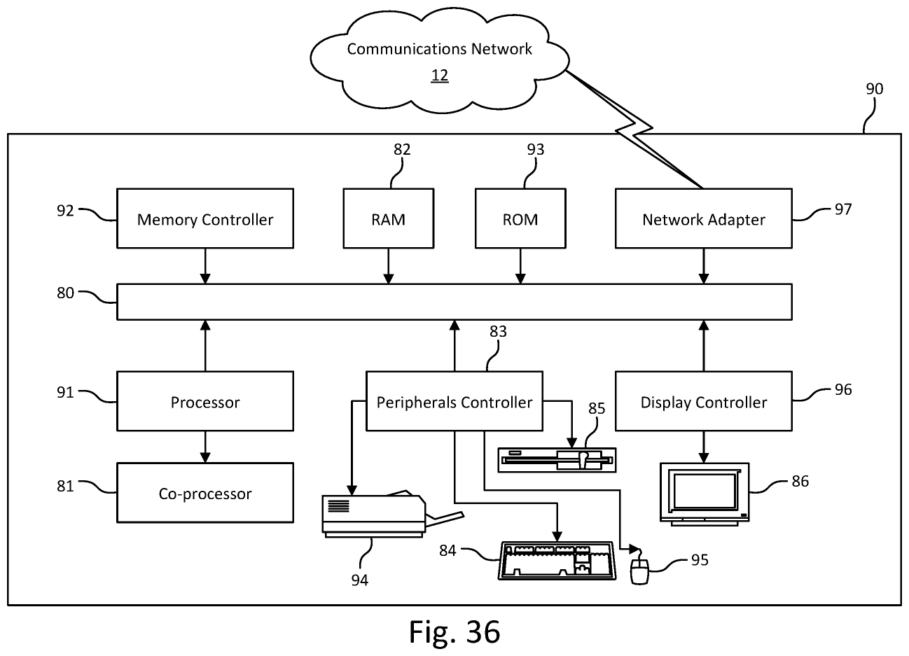

FIG. 36 is a block diagram of an exemplary computing system 90 in which one or more apparatuses of the communications networks illustrated in FIGS. 31, 33, 34, and 35 may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 31-35, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not includes signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which can be used to store the desired information and which can be accessed by a computing system.

1. An apparatus, comprising a processor, a memory, and communication circuitry, the apparatus being connected to a network via its communication circuitry, the apparatus further comprising computer-executable instructions stored in the memory of the apparatus which, when executed by the processor of the apparatus, cause the apparatus to perform operations comprising:
receiving, from a radio network access point (gNB), a beam failure reference signal (BFRS) detection signal, the BFRS detection signal indicating that the gNB has acquired a channel for downlink transmission;
monitoring, during a gNB maximum channel occupancy time (MCOT), a gNB downlink transmission.

2. The apparatus of claim 1, wherein the operations further comprise, monitoring, based on the BFRS detection signal, a beam failure reference signal that is periodic, semi-persistent, or aperiodic.

3. The apparatus of claim 1, wherein the operations further comprise:
monitoring, based on the BFRS detection signal, for a beam failure reference signal within a time window; and
determining, based on measurements during the time window, a beam failure instance.

4. The apparatus of claim 1, wherein the operations further comprise receiving multiple BFRS detection signals before a beam failure reference signal.

5. The apparatus of claim 4, wherein the multiple BFRS detection signals occur at different times or different frequencies.

6. The apparatus of claim 1, wherein the operations further comprise receiving a configuration of a detection signal in static, semi-static, or dynamic way.

7. The apparatus of claim 6, wherein the configuration of the detection signal type is received via radio resource control messaging (RRC), medium access control-control element (MAC-CE), or downlink control indication (DCI), or by a combination of two of more of RRC, MAC-CE, and DCI.

8. The apparatus of claim 1, wherein the operations further comprise:
maintaining a count of missed beam failure reference signal instances; and
reporting, via higher layer signaling, the count of missed beam failure reference signal instances to a serving gNB.

9. The apparatus of claim 8, wherein the operations further comprise reporting, via higher layer signaling, the count of missed beam failure reference signal instances to the serving gNB when the count of missed beam failure reference signal instances exceeds a configured threshold.

10. The apparatus of claim 9, wherein the operations further comprise:
receiving, from a the gNB, a BFRS absence indication, the BFRS absence indication pertaining to an instance of a beam failure reference signal, wherein the instance of the beam failure reference signal is not transmitted due to channel unavailability; and
excluding the instance of the beam failure reference signal from the count of missed beam failure reference signal instances.

11. The apparatus of claim 10, wherein the operations further comprise transmitting, based on the count of missed beam failure reference signal instances, a beam failure recovery request.

12. The apparatus of claim 1, wherein the operations further comprise receiving a gNB response detection signal, the gNB response detection signal indicating that the gNB acquired a channel for response transmission.

13. The apparatus of claim 12, wherein the operations further comprise initiating the monitoring a gNB response transmission based at least in part on the gNB response detection signal.

14. The apparatus of claim 12, wherein the operations further comprise triggering a timer after receiving the gNB response detection signal.

15. An apparatus, comprising a processor, a memory, and communication circuitry, the apparatus being connected to a network via its communication circuitry, the apparatus further comprising computer-executable instructions stored in the memory of the apparatus which, when executed by the processor of the apparatus, cause the apparatus to perform operations comprising:
providing service as a radio network access point;
sending a beam failure reference signal (BFRS) detection signal, the BFRS detection signal indicating that the apparatus has acquired a channel for downlink transmission;
sending a beam failure reference signal;
receiving a beam failure recovery request;
sending a gNB response to the beam failure recovery request.

16. The apparatus of claim 15, wherein the operations further comprise sending a BFRS absence indication, the BFRS absence indication pertaining to a beam failure reference signal instance that is not transmitted due to channel unavailability.

17. The apparatus of claim 15, wherein the operations further comprise sending multiple BFRS detection signals before each of multiple beam failure reference signals.

18. The apparatus of claim 15, wherein the operations further comprise sending multiple BFRS detection signals at different times or different frequencies.

19. The apparatus of claim 13, wherein the operations further comprise sending a configuration of a detection signal in a static, semi-static, or dynamic way.

20. The apparatus of claim 18, wherein the configuration of the detection signal type is sent via radio resource control messaging (RRC), medium access control-control element (MAC-CE), downlink control indication (DCI), or two more of RRC, MAC-CE, and DCI.
